(19) United States
(12) Patent Application Publication
(10) Pub. No.: US 2013/0173494 A1
(43) Pub. Date: Jul. 4, 2013

(54) KNOWLEDGE BOURSE

(71) Applicants: Osama S. TAYEB, Jeddah (SA); Isam AL-FILALI, Jeddah (SA)

(72) Inventors: Osama S. TAYEB, Jeddah (SA); Isam AL-FILALI, Jeddah (SA)

(73) Assignee: KING ABDULAZIZ UNIVERSITY, Kingdom of Saudi Arabia- Jeddah, Jeddah (SA)

(21) Appl. No.: 13/536,539

(22) Filed: Jun. 28, 2012

Related U.S. Application Data
(60) Provisional application No. 61/527,452, filed on Aug. 25, 2011.

(51) Int. Cl. G06Q 40/04

(52) U.S. Cl. CPC G06Q 40/04
USPC 705/36 R; 705/37

(57) ABSTRACT

Exemplary embodiments are disclosed for trading in knowledge stocks and knowledge futures. Systems and methods establish a bourse specialized in trading in various forms of knowledge encompassing inventions and intellectual properties and any type of explicit knowledge that have tangible value in the marketplace. Such value varies according to the supply and demand as well as the financial return that can be accrued by investors in the knowledge market. The creation of a knowledge bourse will provide a market for trading in knowledge stocks and commodities of different types.

### CROSS-REFERENCE TO RELATED APPLICATION

This application claims the benefit of U.S. Provisional Application No. 61/527,452, filed Aug. 25, 2011, which is hereby incorporated by reference in its entirety.

### TECHNICAL FIELD

The present invention relates to financial instruments and the exchange where they are traded. More particularly, the present invention relates to financial instruments comprising knowledge-based stock and knowledge-based commodities for trading on an independent knowledge bourse.

### BACKGROUND

World economies are moving at a fast pace towards an economy that is based on knowledge-based products and services. The knowledge economy is emerging from two defining forces: the rise in knowledge intensity of economic activities, and the increasing globalization of economic affairs. Countries with the highest income are all knowledge economies driven by innovation, which is in turn driven by a high input of science and technology. As Florida & Kenney demonstrated in ‘The New Age of Capitalism,’ capitalism is undergoing an epochal transformation from a mass production system where the principal source of value was human labor, to a new era of ‘innovation-mediated production’ where the principal component of value creation, productivity, and economic growth is knowledge. Accordingly, there is a need to rewrite the rules and practices that once determined success in the industrial economy to fit the knowledge economy.

### SUMMARY

According to exemplary embodiments of the present disclosure, a method is provided for determining knowledge maturity risk. The method includes obtaining knowledge development stages based on technology life cycle, characterizing the knowledge development stages in the context of knowledge tangible outcomes comprising Generate, Transform, Enable, Use Internally, Sell/Transfer, Add Value, Use by Customers, and Evaluate. The method further includes associating a risk weight to each of said outcomes, determining a maturity score as a product of said risk weight and completion status, and determining the knowledge maturity risk based on said maturity score.

According to other embodiments of the present disclosure, a knowledge bourse is provided that includes a plurality of knowledge market offerings comprising knowledge initial public offerings, follow-on knowledge market offerings, secondary knowledge market offerings, and knowledge transfer market offerings. The knowledge bourse further includes a plurality of knowledge financial products comprising knowledge securities based on fungible, negotiable instruments issued by a knowledge-based organization, and a plurality of rules governing activities directed to the knowledge market offerings and knowledge financial products.

According to embodiments of the present disclosure, a knowledge commodities exchange is provided that includes a knowledge spot market wherein knowledge commodities are bought and sold for immediate delivery. The knowledge commodities exchange further includes a knowledge derivatives market comprising a plurality of knowledge commodity financial products including knowledge commodity forward contracts and knowledge commodity futures contracts.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The above and/or other exemplary features and advantages of the preferred embodiments of the present disclosure will become more apparent through the detailed description of exemplary embodiments thereof with reference to the accompanying drawings, in which:

FIG. 1 shows the knowledge maturity level compared to technology readiness level and associated risks in accordance with an exemplary embodiment of the present disclosure;

FIG. 2 depicts the knowledge products/services value chain in accordance with exemplary embodiments of the present disclosure;

FIG. 3 shows the skeletal structure or architecture of a knowledge bourse that resembles traditional exchange markets with appropriate modifications in accordance with exemplary embodiments of the present disclosure;

FIG. 4 shows the process of knowledge initial public offering (KIPO) issuance and maintenance in accordance with an exemplary embodiment of the present disclosure;

FIG. 5 shows details of knowledge securities traded in the knowledge bourse of FIG. 3, including special knowledge financial instruments, in accordance with an exemplary embodiment of the present disclosure;

FIG. 6 depicts the Knowledge Stocks Automated trading process in the knowledge bourse in accordance with an exemplary embodiment of the present disclosure;

FIG. 7 shows the skeletal structure or architecture of a knowledge commodities exchange bourse that resembles traditional commodities exchange markets with appropriate modifications in accordance with exemplary embodiments of the present disclosure;

FIG. 8 shows a combination of knowledge securities exchange bourse of FIG. 3 and the knowledge commodities exchange bourse of FIG. 7 in accordance with an exemplary embodiment of the present disclosure;

FIG. 9 illustrates strategies of the knowledge exchange bourse in accordance with exemplary embodiments of the present disclosure;

FIG. 10 shows the Governance organization of the knowledge exchange bourse in accordance with exemplary embodiments of the present disclosure;

FIG. 11 depicts Governance of the knowledge exchange bourse in accordance with an exemplary embodiment of the present disclosure;

FIG. 12 shows an Organizational Chart of the Knowledge Exchange Bourse in accordance with an exemplary embodiment of the present disclosure;

FIG. 13 displays a flow chart of the Governance Principles of the Knowledge Exchange Bourse in accordance with an exemplary embodiment of the present disclosure;

FIG. 14 shows core functions of the Knowledge Exchange Bourse in accordance with exemplary embodiments of the present disclosure;

FIG. 15 illustrates the maturity of a knowledge-based organization in accordance with exemplary embodiments of the present disclosure based on FIG. 2;

FIG. 16 shows a flow chart of a typical endowment system concept in accordance with an exemplary embodiment of the present disclosure; and

FIG. 17 shows a novel endowment-security system in accordance with an exemplary embodiment of the present disclosure.

Throughout the drawings, like reference numbers and labels should be understood to refer to like elements, features, and structures.

### DETAILED DESCRIPTION

Exemplary embodiments of the present disclosure will now be described more fully with reference to the accompanying drawings. The matters exemplified in this description are provided to assist in a comprehensive understanding of various embodiments disclosed with reference to the accompanying figures. Accordingly, those of ordinary skill in the art will recognize that various changes and modifications of the embodiments described herein can be made without departing from the scope and spirit of the claimed inventions. Descriptions of well-known functions and constructions are omitted for clarity and conciseness. To aid in clarity of description, the terms “upper,” “lower,” “above,” “below,” “left” and “right,” as used herein, provide reference with respect to orientation of the accompanying drawings and are not intended to be limiting.

The financial institution is but one of many institutions impacted by the switch a knowledge economy. However, there are great expectations of the role of this vital institution in providing a stable and solid foundation for the new economy through introduction of new financial instruments and introduction of new types of products that vitalize the global economy. Laws, barriers, taxes and ways to measure knowledge economy are difficult to apply solely on a national basis.

In a knowledge economy, pricing and value of knowledge products depend heavily on context. Knowledge, when locked into systems or processes, has higher inherent value than when it is in people's heads or archived on shelves of depositories and reference vaults. In a knowledge economy, labor costs become progressively less important and traditional economic concepts such as scarcity of resources and economies of scale cease to apply. Nevertheless, resources such as know-how and expertise are as critical as other economic resources.

Knowledge economics are not of scarcity, but rather of abundance since they could flourish in virtual marketplaces and virtual organizations using appropriate technology and methods. Communication is increasingly being seen as fundamental to knowledge flows and long-term success depends on the ability to create and use knowledge faster than competitors. This is reinforced by the creation of business clusters around centers of knowledge, such as research universities and research and development (R&D) centers whether independent or operating under an industrial umbrella.

The majority of research and development (R&D) performed in research institutions, research universities, commercial entities, industries and manufacturing companies rely on external funding, whether from government agencies or from private organizations subsidized by public finance. Exploitation of the commercial potential of any mature conceptual knowledge or transfer of technological knowledge at a high level of readiness into a commercial product requires additional investments unattainable from the traditional R&D funding sources due to the high risk involved. The level of financial exposure is dependent on the level of maturity of the prevailing knowledge in question.

Considering government-financed R&D projects, the finance is greatly tied to the priorities of the funding agency and accordingly can be decreased or totally slashed mid-stream or at a stage at which the knowledge achieved has readily reached a high level of maturity and the engaged organization is left unable to continue the developmental efforts or leverage the achieved knowledge in combination with the well-trained human resources in moving to the market. These situations result not only potential loss of revenue from a lucrative market if the development span has been extended, but also drainage of the expertise that accumulated throughout the R&D stages since the wealth of human resources has to be expunged in favor of pursuing new avenues of interest to the government or the changing priorities of the funding agency.

For example, development of solar energy and other renewable energy sources have witnessed bursts of enthusiasm interrupted by periods of stagnation, neglect and dismantling of expert teams as well as burying the accumulated wealth of knowledge on abandoned shelves and in historical archives, although the need continued to exist and the market persisted beyond experimental tests, prototypes, and subsidized implementations. Some private ventures continued at lower level but found it necessary to divert their resources to more profitable ventures of immediate return. Had there been other sources of finance available to share the risk of development of the acquired knowledge, many of the potential economical products could have been materialized prior to the soaring needs for alternatives to dwindling energy sources.

Aside from funding large conglomerates and small industries to produce and supply products of national interest, government agencies often provide seed money to help private industries prove the technical feasibility and commercial viability of specific innovations with the possibility of attracting private funding to launch new products based on the knowledge gained under active governmental finance. In this case, the private industry has to seek finance from venture capital sources or to establish a joint venture with a large entity. Achieving that is not an easy task especially during times of financial difficulties and uncertain economy. Furthermore, venture capitalists often shy away from investing in areas beyond their familiarity and may require extensive business plans in excess of what the entity seeking the funds can timely provide. On the other hand, large companies that may have the capital to invest in new ventures only participate in joint ventures that are in concert with their other areas of interest. This deprives the small industries not only from seeing viable concepts through to higher levels of maturity but also may deprive those industries of the initial funds available for further development of valuable knowledge due to the lack of identifying follow-on financing sources.

Meanwhile, a wealth of knowledge is abandoned or overlooked representing a host of innovative ideas and concepts, inventions, and partially developed products that could meet a dire need, provide for a competitive edge and/or expand a less than competitive market. Often the owners of intellectual properties have little access to sufficient finance to carry their inventions through the necessary readiness cycle and in most situations cannot trade their knowledge for fair prices in an open market to companies that have the resources to assume the burden of development of ideas or concepts into useful products.

With the extensive reduction in the budgets of public higher education institutions, private academic and higher education institutions and research universities are growing and gaining global popularity in spite of higher tuition fees due to their response to changing job markets for graduates, provision of better education facilities and laboratories, and flexibility in expansion of profitable R&D programs that lead to royalty generating inventions. This trend, coupled with the General Agreement on Trade in Services (GATS) that treats education and knowledge as a commodity, has lead to establishment of institutions that open avenues for investment in higher and middle education. These trends are impeded by fluctuations in the interest rates, rising tuition and fees, shrinkage in long term R&D funding, and lack of capital for expansion. The creation of special financial instruments and establishment of a specialized knowledge bourse for trading in these specially issued instruments would alleviate the financing problems of private and investment institutions. The value of the knowledge stocks issued to finance private and investment education institutions will not be affected by student enrollment alone but also by the long term royalties on inventions resulting from market sponsored R&D. In fact, knowledge stocks can be issued for a novel form of endowment for higher education and other non-profit organizations by issuing endowment shares for sale to the public.

In addition to knowledge producing institutions, there is a new breed of industry with knowledge-intensive products and services; namely, Knowledge-Based Organization (KBO), wherein knowledge forms the core of the product or service. In KBOs, knowledge is often produced and shared as a by-product of daily interactions with customers, vendors, alliance partners and even competitors; effective processes are in place to capture and share knowledge about products, customers, applications, technologies and the competitive environment and new knowledge is created through effective application of existing knowledge. Furthermore, their strategy is by changing the traditional mission from one based on selling traditional products and services to one based on exploitation of knowledge.

Whereas there are various models for the technology readiness cycle and technology maturity levels, there are no models for knowledge maturity levels that encompass the diverse aspects of knowledge other than technology and which can be applied to determine the financial risk associated with each level of maturity as an indicator for use by investors and financial institutions in valuing knowledge and in making decisions regarding investments in moving a specific knowledge forward to the next level. Lack of such models deprives new forms of knowledge and innovations from potential sources of finance.

Accordingly there is a need for financial instruments to make funds available for companies or research institutions desirous of commercialization of the outcome of government funded R&D projects to transfer knowledge into products that meet existing needs while spreading the risk among a larger base of investors.

Further, there is a need for knowledge markets wherein trade in knowledge at different levels can take place without fear of infringements on property rights and wherein the market will determine the tangible value of knowledge.

In addition, there is a need for a knowledge maturity model that identifies the financial risk associated with each level of maturity prior to transfer of the knowledge into technology, products or commodities. This is in addition to means of assignment tangible values to various forms of knowledge.

Furthermore, there is a need for a knowledge bourse that accommodates different forms of knowledge trading and financial instruments, including:
1. Knowledge stock market or equity market wherein shares are issued and traded through, for example, exchanges or over-the-counter (OTC) markets to provide R&D institutions and R&D departments of private companies with access to capital, and investors with a share of ownership in the company and the potential of gains based on the organization's expected future performance. This market can be split into two markets: a primary market wherein new issues are first offered, and a secondary market for any subsequent trading.
2. Knowledge futures market wherein all contracts covering the purchase and sale of knowledge financial instruments or knowledge physical commodities or products are auctioned prior to the anticipated release date of the product to the marketplace for delivery on a specified future date on the commodity futures exchange of the knowledge bourse. A commodity/futures contract is a legally binding agreement to buy or sell a commodity of a specific quality and quantity, at a specified price at a predetermined delivery date and settlement. The infrastructure of the futures exchanges component of the knowledge bourse can resemble traditional futures exchange markets such as the Chicago Mercantile Exchange Inc. in the USA to provide a marketplace where knowledge futures and options on knowledge futures can be traded. Volume in the futures market usually increases when the stock market outlook is uncertain.
3. Knowledge spot market, “knowledge cash market” or “knowledge physical market”, wherein prices are settled in cash on the spot at current market prices, as opposed to forward prices and include: (1) Knowledge commodities or knowledge securities market in which new goods generated from knowledge are sold for cash and delivered immediately. Contracts bought and sold on these markets are immediately effective or (2) Knowledge futures transaction for which knowledge commodities can be reasonably expected to be delivered in one month or less. Though these knowledge goods may be bought and sold at spot prices, the knowledge goods in question are traded on a forward physical market. A spot market can be an organized market, an exchange market or OTC. Spot markets can operate wherever the knowledge bourse infrastructure exists to conduct the transaction. The knowledge spot market for most instruments can exist primarily on the Internet.
4. Knowledge Initial Public Offering (KIPO) that represents the first sale of knowledge stock by a private company or institution to the public, which is often issued by smaller, younger R&D organization seeking the capital to expand, but can also be done by large privately owned R&D organization such as a research institution or a research university looking to become publicly traded. In an KIPO, the issuer obtains the assistance of an underwriting firm, which helps it determine whether to issue common security or preferred security, the best offering price, and the time to bring it to market. KIPOs can be a risky investment. For the individual investor, it is difficult to predict what the stock will do on its initial day of trading and in the near future because there is often little historical data with which to analyze the organization, especially if it's main trade is knowledge. Also, most of the KIPOs are from institutions going through a transitory growth period, which are subject to additional uncertainty regarding their future values.

In addition to the above, there is a need for development of novel trading approaches in the knowledge bourse to facilitate its operation. This is in addition to adaptation, modification or direct adoption of traditional trading methods, tools and roles currently employed in stock and futures markets.

Financial options may be used in the knowledge bourse. In finance, an option is a derivative financial instrument that establishes a contract between two parties concerning the buying or selling of an asset, such as a stock, a bond, a currency or a futures contract at a reference price. The buyer of the option gains the right, but not the obligation, to engage in some specific transaction on the asset, while the seller incurs the obligation to fulfill the transaction if so requested by the buyer. The price of an option derives from the difference between the reference price and the value of the underlying asset plus a premium based on the time remaining until the expiration of the option. In the case of the knowledge bourse, options can in principle be created for any type of valuable asset such as intellectual property, a piece of artwork, rare collection, knowledge leading to deployment of a product, etc.

Generally, there are two primary types of financial options: Exchange-traded options and Over-the-counter options. Exchange-traded options or “listed options” are a class of exchange-traded derivatives that have standardized contracts; that is, accurate pricing models are often available and are settled through a clearing house with fulfillment guaranteed by the credit of the exchange. Exchange-traded options include stock options, commodity options, bond options and other interest rate options, stock market index options or, simply, index options, options on futures contracts and callable bull/bear contract. Over-the-counter options, or “dealer options,” are traded between two private parties and are not listed on an exchange. The terms of an OTC option are unrestricted and may be individually tailored to meet any business need. In general, at least one of the parties to an OTC option is a well-capitalized institution. Option types commonly traded over-the-counter include interest rate options, currency cross-rate options, and options on swaps or swaptions.

Typically, any Exchange provides a “clearing house,” which is a division of the Exchange through which all trades must be confirmed, matched, and settled each day until offset or delivered. The clearing house is an adjunct to the Exchange responsible for settling trading accounts, clearing trades, collecting and maintaining performance bond funds, regulating delivery, and reporting trading data. Clearing is the procedure through which the Clearing House becomes buyer to each seller of a futures contract, and seller to each buyer, and assumes responsibility for protecting buyers and sellers from financial loss by assuring performance on each contract.

An option that conveys the right to buy something is a call, while an option that conveys the right to sell is a put. The reference price at which the underlying asset may be traded is called the strike price or exercise price. In the case of futures, a put option grants the right, but not the obligation, to sell a futures contract at the stated price prior to the expiration date. In contrast, a call option contract gives the buyer the right, but not the obligation, to purchase a specific futures contract at a fixed price (strike price) within a specified period of time according to the contract specifications designated by the futures Exchange. The process of activating an option and thereby trading the underlying asset at the agreed-upon price is referred to as exercising the option. Most options have an expiration date. If the option is not exercised by the expiration date, it becomes void and worthless.

The buyer has the right to buy the commodity (underlying futures contract) or enter a long position, that is, a position in which the trader has bought a futures contract that does not offset a previously established short position. A call writer (seller) has the obligation to sell the commodity (or enter a short position, which is the opposite of a long position) at a fixed price (strike price) during a certain fixed time when assigned to do so by the Clearing House. The term “short” refers to sale of a futures contract to establish a market position that has not yet closed through an offsetting procedure, i.e., the opposite of long. Generally, an offset refers to taking a second futures or option on futures position opposite to the initial or opening position, for example, selling if one has bought, or buying if one has sold.

In return for granting the option, called writing the option, the originator of the option collects a payment (the premium) from the buyer. The writer of an option must make good on delivering (or receiving) the underlying asset, or its cash equivalent if the option is exercised.

An option can usually be sold by its original buyer to another party. Many options are created in standardized form and traded on an anonymous options exchange among the general public, while over-the-counter options are customized to the desires of the buyer on an ad hoc basis, usually by an investment bank.

To cover some or all of the credit risk arising if the holder of a financial instrument has borrowed cash from a counterparty (most often a broker or an exchange) to buy financial instruments, sold financial instruments short, or entered into a derivative contract, the holder must deposit collateral with the counterparty. Collateral can be in the form of cash or securities, and it is deposited in a margin account or what was previously known as performance bond.

Knowledge forms a substantial part of daily public life whether through education, cultural events, media, exposure to the tools of knowledge or benefits derived from the fruits of knowledge and hence there is a need to involve a large segment of the population in the activities of the knowledge bourse to have a great impact on them. In a democracy, the finance of education, R&D, innovation, and future progress should not be dominated by the choices of the institutional traders.

Share prices of companies traded in a stock exchange market reflect activities such as new discoveries that may lead to a successful line of products or the release of a new product and the success of the product in penetrating the market in terms of sale volume and competitiveness with similar products. In other words, new knowledge boosts a company's position in the financial market. Usually such events and the preceding R&D activities do not require offering special classes of stocks. However, established companies can protect their stock from drastic fluctuations associated with success or failure of introducing new products based on ongoing R&D activities by offering a separate stock or class of stock specially designed to finance the development of each major product until reaching a stable position in the market. Exemplary embodiments provide for such special stock to be absorbed by the company's major stocks when price has stabilized.

On the other hand, entrepreneurs form companies based on exploitation of a novel idea or invention to develop specific products with the prospective of meeting an existing need of a specific consumer sector or an existing demand in the marketplace. However, entrepreneurs lack the resources for financing their ventures without surrendering their intellectual property to an established organization or investor until a buyer is interested in realizing its potential. By accessing a stock market specialized in high risk ventures, they can fund the process of converting their inventions into tangible products that have high potential in the marketplace through design and demonstration of prototypes, surpassing all the development risk levels and taking the final steps to produce a working technology that passes extensive field tests or produce full-fledged products. Once the products are established and the company has a business niche in the marketplace, the company may be acquired or its stock may be traded in the traditional stock market.

R&D institutions, R&D divisions in established companies, and R&D arms of research universities and higher education establishments are in continuous and exhaustive pursuit of public grants and research contracts. Competition among the many for the little from the few diverge the skillful efforts from development to grant hunting and diverts the creative energy to knowledge sustenance. Concurrently, unique timely concepts and serious initiatives to solve urgent problems may fall through the cracks and never surface again. Even in cases of successful acquisition of public finance, uninterrupted continuation until achievement of an R&D objective is not guaranteed regardless of the degree of success in reaching the program goals. Often enough the amount of the grant or support is not sufficient to seriously pursue the stated program goals.

Since competition for funds is among diverse ideas, ideas that are funded are not necessarily the most likely to succeed since selection criteria do not necessarily relate to the likelihood of success in commercialization but is dependent on the ability of the funded entity to commercialize its end results.

An organization may be able to acquire funds from the financial market through an initial public offering in a special stock market such as a knowledge bourse to finance a multi-component program that involves a variety of projects. Success of some projects in developing a marketable product can offset losses in other programs that involve higher levels of risk.

Alternately, a group of research institutions or R&D organizations may wish to group their resources and issue special stocks in a knowledge bourse to fund their R&D programs. The group would join forces, share resources, and collaborate in issuance of a joint prospective detailing their programs and the risk associated with their collaborative financial scheme. The financial instrument thus created would have lower risk on the average compared to individual issuance of stocks and would reduce the financial burdens of issuance of the special knowledge stock. The joint special knowledge stock would be similar to joint ventures among the investors. Such joint ventures can operate on a global level while maintaining the competition between the participating R&D constituents.

There is a vast difference between valuation of knowledge products and technological products in the stock exchange and commodity markets. Technological maturity passes by five distinct stages; namely bleeding edge, leading edge, state-of-the-art, dated and obsolete wherein bleeding edge technology is highly risky, the leading edge products could be the highest in value but also the highest in risk during to uncertainty shrouding the market of such products, while the highest stable value is accrued for state-of-the-art products. The later stages of maturity represent a dwindling value that diminishes when reaching obsolesce. In contrast, maturity of knowledge is associated with increase in value and decrease in risk.

Special financial instruments can be specifically developed and introduced for trading of several new knowledge-related financial products in the knowledge bourse, such as the value of existing exceptional human assets in an R&D organization that add value to the activity of the organization. For example, the presence of Noble Laureates on the faculty or research team of a research institution is likely to attract high caliber researchers as well as funded R&D projects. Such a product does not represent a life insurance on an individual or individuals, but rather on their contribution to the potential of acquisition of funding contracts and grants, innovations, inventions, moving knowledge across transitional levels to actual production of goods or services, etc.

Examples of stocks to be traded in the knowledge bourse are shares in Knowledge-based industries and KBOs that supply products/services such as, but not limited to:
Printed/Electronic Products/Services: For example, books, newspapers, syndication articles, periodicals, manuscripts, forms and templates, policies/regulations, business plans and processes/procedures; training manuals and practitioner's guides; statistics and qualitative/quantitative data, etc.;
Audio/Video Products (stored at any type of media)/Services: For example, movies; songs; plays; books; TV shows, episodes and programs; documentaries on variety of topics covering educational and/or entertainment, etc.;
Internet-Based Products/Services: For example, eBooks, self-paced educational and training courses delivered online, interactive eLearning products, statistics/data (qualitative and quantitative), audio/video products/services, information, etc.;
Software Products/Services: For example, open source software, applications software, software development and testing tools, operating systems, computer codes, legacy computation programs, etc.; and
Methods/Tools Products/Services: For example, methods/frameworks; tools: conceptual and analytical tools and models, simulations, applications; information: indicators, databases, bibliographies, proprietary information, best/leading practices; patents, etc.

The process of creation of data, the processing of data into information, and the subsequent dissemination of data as knowledge for research, education, social and economic valuation and capacity development has never been faster than with current broad-band Internet. Knowledge exchange is the lifeblood of the new marketplace. Globalization increases the speed and value of knowledge exchange, where knowledge and information circle the globe in microseconds and where your competitor becomes your customer, forming collaborations once thought impossible.

The knowledge bourse is also able to trade in securities financing exhibits; specific theatrical plays, documentaries and movies; knowledge publishing and dissemination, such as encyclopedias and documentations of new knowledge. The value of such instruments can be determined by temporal metrics related to the knowledge commodity in question, for example, the success of exhibits in case of artwork, tickets sales and extension of performance in case of theatrical production. This is in addition to commodities, such as artworks, art collections; special precious relics; antiques; historical, legacy and old manuscripts and documents; software, including legacy non-proprietary computation programs and computer codes, application software, etc.

Accordingly, exemplary embodiments of the present invention create a bourse or financial business enterprise dedicated to trade in financial instruments specially designed for exchange of knowledge assets (securities and commodities), products, services and activities under fair and equitable terms to establish international standards and official platforms for exchanging knowledge-based products and services, using in-depth market knowledge, sound risk management practices, and first class customer service.

Exemplary embodiments of the present invention create a knowledge bourse in which special stock can be issued and traded based on prospectus of high risk ventures, including specific concepts that have not been proven, products prior to introduction to the marketplace, during product marketplace tests or after introduction to the marketplace while penetration of the market remains questionable or subject to fluctuation.

Exemplary embodiments of the present invention establish a special knowledge bourse wherein special classes of stock are issued and traded to provide finance to develop and realize innovative concepts without the need for public finance, or in addition to partial public finance in order to accelerate the development of a concept into a product, such as a vaccine for a new virus. Each class of stock would carry a different risk profile.

Exemplary embodiments of the present invention establish a Knowledge Bourse (KB) as an important not-for-profit funding source for knowledge-based organizations to raise capital through selling knowledge shares to investors and assist participating organizations in issuing dividends to investors.

Exemplary embodiments of the present invention establish a Knowledge Bourse (KB) as an organized marketplace in which members (individual and institutional investors) can freely buy and sell various knowledge commodities to provide those members with facilities, ground rules and a fair opportunity to trade in knowledge securities and commodity futures while facilitating trade for non-members by dealing through a member broker and paying a brokerage commission.

Exemplary embodiments of the present invention provide a financial instrument for new companies to raise capital to develop a commercially viable product while spreading the risk over a large base of willing investors, while being exposed to a calculated risk for a potential of much higher returns.

Exemplary embodiments of the present invention provide a financial instrument that bundles financial needs of a diverse group of R&D programs of different risk levels, such that the financial risk of the instrument is at a median range between the highest risk component and the lowest risk component. The programs may belong to one institution or a group of collaborating research institutions.

Exemplary embodiments of the present invention establish a knowledge bourse wherein collaborating R&D institutions can issue joint financial instruments for trading in the bourse.

Exemplary embodiments of the present invention to establish a knowledge bourse wherein trading takes place in a similar fashion to the stock exchange and futures exchange markets, preferably the infrastructure of the new bourse would encourage participation of individuals through simplification of Internet trading and providing a knowledge maturity model that assigns risk to different stages of the knowledge readiness cycle.

Still further exemplary embodiments of the present invention develop an extensive range of financial instruments, financial products, tools and services to meet clients' needs and to help knowledge business and knowledge-based economy thrive and grow.

Exemplary embodiments of the present invention add value to the knowledge products and services capital-raising and trading process by providing the highest-quality and most cost-effective self-regulated marketplace for trading knowledge-based financial instruments and commodities.

In one aspect of the exemplary embodiments of the present invention, the knowledge bourse is envisioned as an adoption of the structure, the trading methods, and the rules of a traditional stock exchange. However, trading on the knowledge bourse is focused on offerings related to knowledge-based organizations, including knowledge industries, companies specialized in knowledge products and goods, and institutions engaged in various fields of explicit and tangible knowledge, such as different forms of art, culture, education, research and knowledge services.

One exemplary embodiment of the present invention involves the introduction of special knowledge financial instruments in the knowledge bourse. In addition to traditional securities, including endowments for not-for-profit institutions such as research institutions and academic institutions of higher learning, R&D projects whether on individual basis or in clusters, building exceptional human capital, knowledge exchange and clearing houses, think tanks, etc.

In aspects of exemplary embodiments of the present invention, the knowledge bourse is based on adoption of the structure, the trading methods and rules of a traditional commodities exchange. However, trading on the knowledge bourse is focused on various knowledge commodities and derivative products. The knowledge commodity market trades in essential knowledge products and other usable basic knowledge (such as applications software, patented inventions, copyrighted materials, etc.) leading to consumable goods and contracts based on them.

An alternative embodiment of the present invention is the combination of security exchange and commodity exchange under one knowledge bourse wherein special knowledge financial instruments and financial products are traded besides the traditional instruments and forms of knowledge-related stocks and commodities.

Another aspect of exemplary embodiments of the present invention is the creation of a knowledge bourse that handles trading in special high-risk, high prospect financial products related to clusters of knowledge ventures.

An exemplary embodiment of the present invention, trading in the knowledge bourse is dominated by Internet mediated trading.

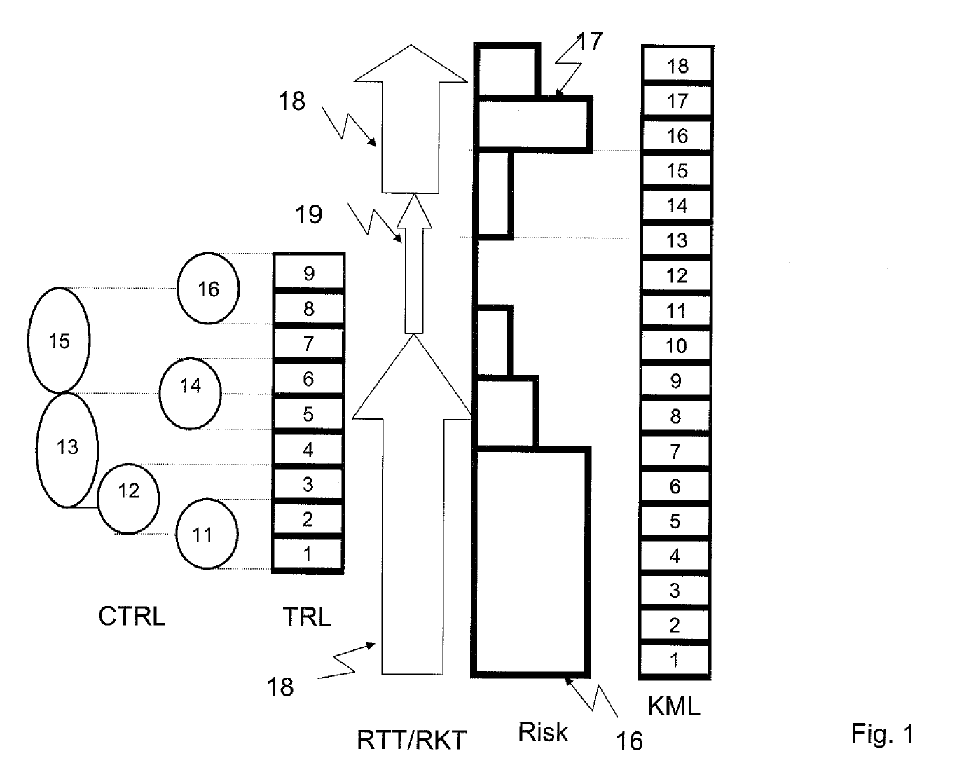

FIG. 1 illustrates knowledge maturity level compared to technology readiness and associated risks in accordance with exemplary embodiments of the present invention. A knowledge maturity model is envisioned to be used in determination of the risks associated with different stages of development of knowledge in the context of technology life cycle. The risk associated with the technology life cycle is usually represented by the risk of technology transition from a concept to the market and expressed by nine levels on a scale of Technology Readiness Level (TRL) as listed in Table 1. The nine levels can be consolidated into 6 levels as shown in FIG. 1 and represented by the Consolidated Technology Readiness Level (CTRL) in Table 2.

TABLE 1
Technology Readiness Level (TRL)

| | |
|---|---|
| TRL 1 | Basic principles observed and reported |
| TRL 2 | Technology concept and/or application formulated |
| TRL 3 | Analytical and experimental critical function and/or characteristic |
| | proof of concept |
| TRL 4 | Component and/or breadboard validation in laboratory |
| | environment |
| TRL 5 | Component and/or breadboard validation in relevant environment |
| TRL 6 | System/subsystem model or prototype demonstration in a |
| | relevant environment |
| TRL 7 | System prototype demonstration in a actual environment |
| TRL 8 | Actual system completed and qualified through test and |
| | demonstration |
| TRL 9 | Actual system proven through successful mission operations |

TABLE 2
Consolidated Technology Readiness Level (CTRL)

| | |
|---|---|
| CTRL 11 | Basic technology research |
| CTRL 12 | Research to prove feasibility |
| CTRL 13 | Technology development |
| CTRL 14 | Technology demonstration |
| CTRL 15 | System/subsystem development |
| CTRL 16 | System test, launch & operation |

The risks associated with the technology readiness levels is estimated semi-quantitatively by FIG. 1 wherein the risk 17 is about 100% from TRL 1 to half way between TRL 3 and TRL 4; then is reduced by about 50% to half way between TRL 5 and TRL6; then is reduced by another 50% to half way between TRL 7 and TRL 8 and almost nil to the end of TRL 9. Risk 17 represents the unknowns associated with the technology at the TRL stages. High risk for technology transition (RTT) 18 extends from the start till midway between TRL 6 and TRL 7, followed by low risk for technology transition 19.

In contrast, the knowledge maturity level (KML) include 3 levels before the level corresponding to TRL 1 and 6 levels following TRL 9 as given in Table 3.

TABLE 3
Knowledge Maturity Level (KML)

| | |
|---|---|
| KML 1 | Idea captured from existing needs or inferred from other situations |
| KML 2 | Hypotheses speculated |
| KML 3 | Basic principles established |
| KML 4. | Basic principles observed and reported |
| KML 5 | Concept and/or application formulated |
| KML 6 | Analytical and experimental critical function and/or characteristic proof of concept |
| KML 7 | Knowledge realized in component and/or breadboard validation in laboratory |
| | environment |
| KML 8 | Knowledge realized in component and/or breadboard validation in relevant |
| | environment |
| KML 9 | Knowledge realized in model or prototype demonstration in a relevant environment |
| KML 10 | Knowledge realized in prototype demonstration in an actual environment |
| KML 11 | Knowledge realized in actual system completed and qualified through test and |
| | demonstration |
| KML 12 | Knowledge realized in actual system proven through successful mission operations |
| KML 13 | Knowledge becoming cutting edge |
| KML 14 | Knowledge becoming state of the art |
| KML 15 | Knowledge improvements |
| KML 16 | Knowledge becoming dated |
| KML 17 | Knowledge becoming obsolete |
| KML 18 | Legacy knowledge archived |

As they relate to technology, KML 1 through KML 12 may be considered as bleeding edge knowledge; that is, any knowledge that has a high potential of leading to a commercially viable product but has yet to be market tested. Although these levels in terms of technology refer to the whole spectrum of technology readiness from TRL 1 through TRL 9, the product has to demonstrate its value or settle down into any kind of consensus. Early adopters may win big, or may be stuck with a white elephant. KML 13, cutting edge knowledge, is equivalent to leading edge technology; that is, a technology that has proven itself in the marketplace but is still new enough that it may be difficult to find knowledgeable personnel to implement or support it. KML 14 represents state of the art when everyone agrees that a particular knowledge/technology is the right solution. The state of the art knowledge can be on the frontier of knowledge through continuous efforts of improvement, KML 15. When all possible improvement paths are exhausted knowledge becomes dated, KML 16; that is, it is still useful, still sometimes implemented, but a replacement cutting edge knowledge or leading edge technology is readily available. Eventually, KML 17 is reached and knowledge becomes obsolete when it has been superseded by state-of-the-art knowledge/technology. Such knowledge may be maintained but no longer implemented. However, documentation and critique of obsolete knowledge can be of value as legacy knowledge archives, KML 18.

The semi-quantitative risk associated with knowledge maturity levels can be extended relative to that associated with the TRLs, such as in FIG. 1 wherein the risk 17 is about 100% from KML 1 to half way between KML 6 and KML 8; then is reduced by about 50% to half way between KML 8 and KML 10; then is reduced by another 50% to half way between KML 10 and KML 12; and almost nil between KML 12 and KML 14. However, the risk 17 increases to the level prior to the nil level until the end of KML 15 which represents improvements on the state of the art, following KML 15 the risks 17 or the unknowns associated with the knowledge maturity is almost tripled throughout KML 16 till midway between KML 16 and KML 18. As the final stage is approached at KML 19, the Risk 17 is reduced by 50% again. High risk for knowledge transition 18 extends from the start till midway between KML 9 and KML 11, followed by low risk for knowledge transition 19 to midway between KML 13 and KML 15, then returns to High risk for knowledge transition 18 throughout KML 19.

When knowledge maturity levels are interpreted in the context of knowledge tangible outcomes they may be consolidated into Knowledge Maturity Product/Service Model wherein the Knowledge Maturity Product/Service Levels are as in Table 4.

TABLE 4
Knowledge Products/Services Maturity Levels

| | | Sub- | |
|---|---|---|---|
| KMPL | Action | KIMPL | Activity |
| 1 | Generate | 1-1 | Formulate Basic ideas |
| | | 1-2 | Perform Basic research |
| | | 1-3 | Observe and report Principles |
| | | 1-4 | Generate Content with intrinsic value and potential |
| | | | usefulness |
| 2 | Transform | 2-1 | Formulate Concepts and/or applications |
| | | 2-2 | Transform Contents into prototypes |
| | | 2-3 | Characteristic proof-of-concept |
| | | 2-4 | Demonstrate Prototypes in an operational environment |
| | | 2-5 | Start Patent - Copyright and/or trademark process |
| 3 | Enable | 3-1 | Generate New knowledge products/services to permit use |
| | | 3-2 | Validate Products/services in controlled environment |
| | | 3-3 | Validate Products/services in operational environment |
| 4 | Use | 4-1 | Use Knowledge products/services internally and prove |
| | Internally | | usefulness |
| | | 4-2 | Package Products/services for external use |
| 5 | Sell/transfer | 5-1 | Sell/transfer Knowledge products/services to customers to |
| | | | enable external use |
| 6 | Add value | 6-1 | Increase availability, utility, or add value to knowledge |
| | | | products/services by intermediaries |
| 7 | Use by | 7-1 | Use Knowledge products/services by customers with related |
| | customers | | knowledge to benefit identified sectors/markets |
| 8 | Evaluate | 8-1 | Evaluate Knowledge products/services to improve |
| | | | performance, derive new products to support future demands |
| | | | of other sectors/markets |

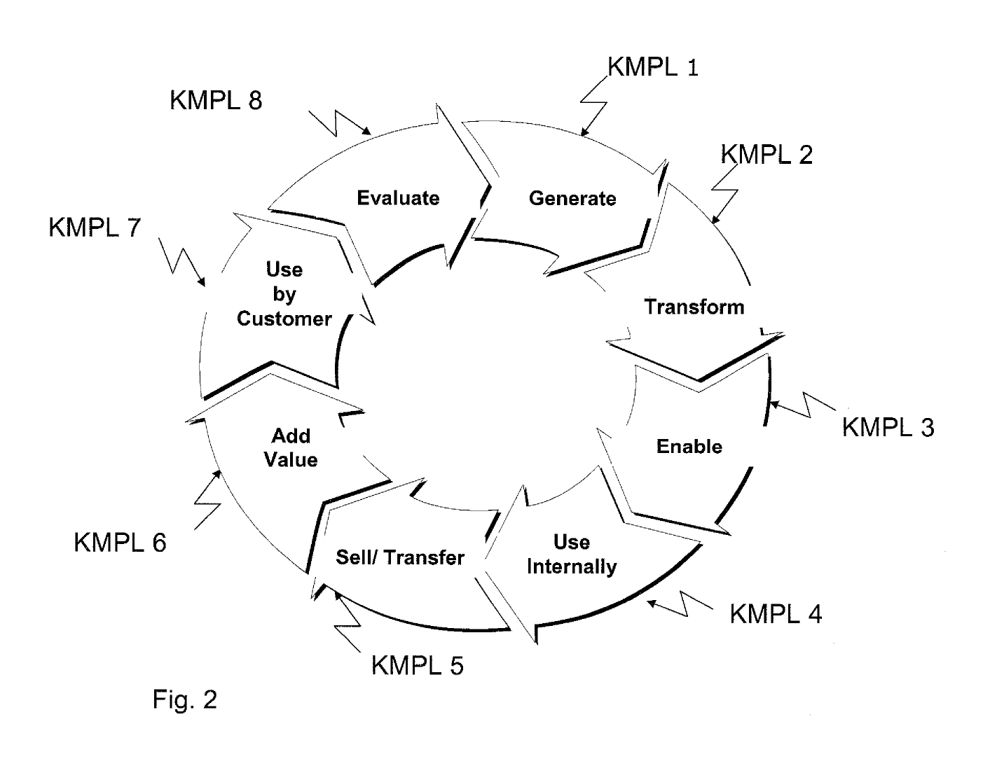

FIG. 2 depicts the knowledge products/services value chain in accordance with exemplary embodiments of the present disclosure. In FIG. 2 the knowledge products/services value chain describes a sequence of steps associated with the KMPLs in which knowledge inputs are transformed into refined and higher-value outputs and subsequently sold to consumers. Throughout the KMPL 1 (Generate), content with intrinsic value and potential usefulness is generated as the first stage of the knowledge products/services value chain and the content is transformed into products/services to increase its usefulness or value to users in KMPL 2 (Transform). The flows of knowledge products/services are enabled to permit their sell/transfer to customers in KMPL 3 (Enable). In KMPL 4, knowledge products/services are used internally to accomplish organizational objectives while knowledge products/services are sold/transferred to customers to enable external use in KMPL 5. The added-value KMPL 6 involves work to be done by intermediaries to increase the availability, utility, or value of knowledge products/services. In KMPL 7, knowledge products/services are used by clients with sector-related knowledge to benefit an identifiable sector. The chain ends by KMPL 8 wherein the system is evaluated to improve its performance to support demands of knowledge market leading to restart of the Generate KMPL 1, and so on.

Furthermore the risks associated with the Knowledge Maturity Product/Service Levels are divided into three risk levels; high, medium and low as given in Table 5. The maturity score is given by:

Maturity score=Risk Weight*Completion Status×100

Where completion status is yes (completed) or no (not completed), that is 1 or 0 respectively. Understanding and assessment of the maturity of knowledge-based organizations aid in establishing critical times for preparation for knowledge initial public offering (KIPO), issuance of the KIPO, trading in the knowledge stock exchange, and trading in the knowledge commodities exchange.

TABLE 5
Knowledge maturity score

| Sub- | | | | Completion Maturity | |
|---|---|---|---|---|---|
| KIMPL | Activity | Risk | Weight | (0 or 1) | Score |
| 1-1 | Formulate Basic ideas | High | 0.02 | | |
| 1-2 | Perform basic research | | 0.02 | | |
| 1-3 | Observe and report Principles | | 0.02 | | |
| 1-4 | Generate content with intrinsic value | | 0.04 | | |
| | and potential usefulness | | | | |
| 2-1 | Formulate concepts and/or | | 0.04 | | |
| | applications | | | | |
| 2-2 | Transform contents into prototypes | | 0.04 | | |
| 2-3 | Characteristic proof-of-concept | | 0.04 | | |
| 2-4 | Demonstrate prototypes in an | | 0.04 | | |
| | operational environment | | | | |
| 2-5 | Start patent - copyright and/or | | 0.05 | | |
| | trademark process | | | | |
| 3-1 | Generate new knowledge products/ | Medium | 0.1 | | |
| | services to permit use | | | | |
| 3-2 | Validate products/services in | | 0.1 | | |
| | controlled environment | | | | |
| 3-3 | Validate products/services in | | 0.1 | | |
| | operational environment | | | | |
| 4-1 | Use knowledge products/services | | 0.1 | | |
| | internally and prove usefulness | | | | |
| 4-2 | Package products/services for | Low | 0.1 | | |
| | external use | | | | |
| 5-1 | Sell/transfer knowledge | | 0.1 | | |
| | products/services to customers to | | | | |
| | enable external use | | | | |
| 6-1 | Increase availability, utility, or add | | 0.03 | | |
| | value to knowledge products/services | | | | |
| | by intermediaries | | | | |
| 7-1 | Use Knowledge products/services by | | 0.03 | | |
| | customers with related knowledge to | | | | |
| | benefit identified sectors/markets | | | | |
| 8-1 | Evaluate Knowledge | | 0.03 | | |
| | products/services to improve | | | | |
| | performance, derive new products to | | | | |
| | support future demands of other | | | | |
| | sectors/markets | | | | |
| | Total | | 1 | 18 | 0-100 |

Table 6 lists the relationship of the Maturity Score and the risk level.

TABLE 6

| Maturity Score | Risk |
|---|---|
| ≦31 | High |
| >31 ≦ 71 | Medium |
| >71 ≦ 100 | Low |

A list of five categories of knowledge products/services is provided in Table 7, wherein:
⁽¹⁾Products are in printed or electronic format, in any language;
⁽²⁾Products/services are stored in any storage media format;
⁽³⁾Products/services are downloaded or interactive via an internet;
⁽⁴⁾Products/services stored on any media or downloaded via internet; and
⁽⁵⁾Products/services are printed/electronic/stored on any media or downloaded via internet.

Three examples are provided for which the risk level is computed from the overall maturity score in each case. In the first example a patent has just been issued (Table 8) the maturity score is 31, which means that the risk is high. In the second example (Table 9) a book has been edited, proofed and is ready for publishing. The maturity score is 71, which means that the risk is medium. In the third Example (Table 10) a book has been published, becomes a best seller, a movie script has been prepared. The book as a knowledge product has become a low risk with a maturity score estimated at 97.25, whereas the movie as a product is still high risk with a maturity score of 14.

TABLE 7
Knowledge Products/Service

| Printed/Electronic⁽¹⁾ | Audio/Video⁽²⁾ | Internet-Based⁽³⁾ | Software⁽⁴⁾ | Methods/Tools⁽⁵⁾ |
|---|---|---|---|---|
| Books | Books | eBooks | Open Source | Methods/ |
| | | | Software | Frameworks |
| Papers, Articles | Songs | Self-paced | Applications | Conceptual |
| | | educational | Software | Tools |
| Periodicals | Plays | Self-paced Training | Software | Analytical Tools |
| | | Topics | Development | |
| | | | Tools | |
| Research | Movies | eLearning products | Software | Models |
| | | | Testing Tools | Applications |
| Scripts (books, | TV Shows | Statistics/Data | Operating | Simulations |
| movies, plays, etc.) | | | Systems | Applications |
| Know-How Manuals | TV Episodes | Printed/Electronic⁽¹⁾ | | Indicators |
| Forms, Templates | TV Programs | Audio/Video⁽²⁾ | | Databases |
| Business Processes/ | Educational | | | Bibliographies |
| Procedures | Topics | | | |
| Business Plans | Entertaining | | | Proprietary |
| | Topics | | | Information |
| Polices/Regulations | | | | Best/Leading |
| | | | | Practices |
| Best Practices | | | | Patents |
| Practitioners' Guides | | | | |
| Training Methods | | | | |
| Statistics/ Data | | | | |

TABLE 8
Example 1

| | | | Completion | Maturity |
|---|---|---|---|---|
| # | Activity | Weight | (0 or 1) | Score |
| 1-1 | Formulate Basic ideas | 0.02 | 1 | 2 |
| 1-2 | Perform Basic research | 0.02 | 1 | 2 |
| 1-3 | observe and report Principles | 0.02 | 1 | 2 |
| 1-4 | Generate Content with intrinsic value and | 0.04 | 1 | 4 |
| | potential usefulness | | | |
| 2-1 | Formulate Concepts and/or applications | 0.04 | 1 | 4 |
| 2-2 | Transform Contents into prototypes | 0.04 | 1 | 4 |
| 2-3 | Characteristic proof-of-concept | 0.04 | 1 | 4 |
| 2-4 | Demonstrate Prototypes in an operational | 0.04 | 1 | 4 |
| | environment | | | |
| 2-5 | Start Patent - Copyright and/or trademark process | 0.05 | 1 | 5 |
| 3-1 | Generate New knowledge products/ services to | 0.1 | 0 | 0 |
| | permit use | | | |
| 3-2 | Validate Products/services in controlled | 0.1 | 0 | 0 |
| | environment | | | |
| 3-3 | Validate Products/services in operational | 0.1 | 0 | 0 |
| | environment | | | |
| 4-1 | Use Knowledge products/services internally and | 0.1 | 0 | 0 |
| | prove usefulness | | | |
| 4-2 | Package Products/services for external use | 0.1 | 0 | 0 |
| 5-1 | Sell/transfer Knowledge products/services to | 0.1 | 0 | 0 |
| | customers to enable external use | | | |
| 6-1 | Increase availability, utility, or add value to | 0.03 | 0 | 0 |
| | knowledge products/services by intermediaries | | | |
| 7-1 | Use Knowledge products/services by customers | 0.03 | 0 | 0 |
| | with related knowledge to benefit identified | | | |
| | sectors/markets | | | |
| 8-1 | Evaluate Knowledge products/services to improve | 0.03 | 0 | 0 |
| | performance, derive new products to 0support | | | |
| | future demands of other sectors/markets | | | |
| | Total | 1 | 9 | 31 |

TABLE 9
Example 2

| | | | Completion | Maturity |
|---|---|---|---|---|
| # | Activity | Weight | (0 or 1) | Score |
| 1-1 | Formulate Basic ideas | 0.02 | 1 | 2 |
| 1-2 | Perform Basic research | 0.02 | 1 | 2 |
| 1-3 | observe and report Principles | 0.02 | 1 | 2 |
| 1-4 | Generate Content with intrinsic value and potential | 0.04 | 1 | 4 |
| | usefulness | | | |
| 2-1 | Formulate Concepts and/or applications | 0.04 | 1 | 4 |
| 2-2 | Transform Contents into prototypes | 0.04 | 1 | 4 |
| 2-3 | Characteristic proof-of-concept | 0.04 | 1 | 4 |
| 2-4 | Demonstrate Prototypes in an operational | 0.04 | 1 | 4 |
| | environment | | | |
| 2-5 | Start Patent - Copyright and/or trademark process | 0.05 | 1 | 5 |
| 3-1 | Generate New knowledge products/services to | 0.1 | 1 | 10 |
| | permit use | | | |
| 3-2 | Validate Products/services in controlled | 0.1 | 1 | 10 |
| | environment | | | |
| 3-3 | Validate Products/services in operational | 0.1 | 1 | 10 |
| | environment | | | |
| 4-1 | Use Knowledge products/services internally and | 0.1 | 1 | 10 |
| | prove usefulness | | | |
| 4-2 | Package Products/services for external use | 0.1 | 0 | 0 |
| 5-1 | Sell/transfer Knowledge products/services to | 0.1 | 0 | 0 |
| | customers to enable external use | | | |
| 6-1 | Increase availability, utility, or add value to | 0.03 | 0 | 0 |
| | knowledge products/services by intermediaries | | | |
| 7-1 | Use Knowledge products/services by customers | 0.03 | 0 | 0 |
| | with related knowledge to benefit identified | | | |
| | sectors/markets | | | |
| 8-1 | Evaluate Knowledge products/services to improve | 0.03 | 0 | 0 |
| | performance, derive new products to 0support | | | |
| | future demands of other sectors/markets | | | |
| | Total | 1 | 13 | 71 |

TABLE 10
Example 3

| | | | Book | | | |
|---|---|---|---|---|---|---|
| | | | Com- | | | |
| | | | pletion | Maturity | | |
| # | Activity | Weight | (0 or 1) | Score | Movie | |
| 1-1 | Formulate Basic ideas | 0.02 | 1 | 2 | 1 | 2 |
| 1-2 | Perform Basic research | 0.02 | 1 | 2 | 1 | 2 |
| 1-3 | observe and report Principles | 0.02 | 1 | 2 | 1 | 2 |
| 1-4 | Generate Content with intrinsic | 0.04 | 1 | 4 | 1 | 4 |
| | value and potential usefulness | | | | | |
| 2-1 | Formulate Concepts and/or | 0.04 | 1 | 4 | 1 | 4 |
| | applications | | | | | |
| 2-2 | Transform Contents into | 0.04 | 1 | 4 | 0 | 0 |
| | prototypes | | | | | |
| 2-3 | Characteristic proof-of-concept | 0.04 | 1 | 4 | 0 | 0 |
| 2-4 | Demonstrate Prototypes in an | 0.04 | 1 | 4 | 0 | 0 |
| | operational environment | | | | | |
| 2-5 | Start Patent-Copyright and/or | 0.05 | 1 | 5 | 0 | 0 |
| | trademark process | | | | | |
| 3-1 | Generate New knowledge | 0.1 | 1 | 10 | 0 | 0 |
| | products/services to permit use | | | | | |
| 3-2 | Validate Products/services in | 0.1 | 1 | 10 | 0 | 0 |
| | controlled environment | | | | | |
| 3-3 | Validate Products/services in | 0.1 | 1 | 10 | 0 | 0 |
| | operational environment | | | | | |
| 4-1 | Use Knowledge products/ | 0.1 | 1 | 10 | 0 | 0 |
| | services internally and prove | | | | | |
| | usefulness | | | | | |
| 4-2 | Package Products/services for | 0.1 | 1 | 10 | 0 | 0 |
| | external use | | | | | |
| 5-1 | Sell/transfer Knowledge | 0.1 | 1 | 10 | 0 | 0 |
| | products/services to customers | | | | | |
| | to enable external use | | | | | |
| 6-1 | Increase availability, utility, | 0.03 | 1 | 10 | 0 | 0 |
| | or add value to knowledge | | | | | |
| | products/services by | | | | | |
| | intermediaries | | | | | |
| 7-1 | Use Knowledge products/ | 0.03 | 1 | 10 | 0 | 0 |
| | services by customers with | | | | | |
| | related knowledge to benefit | | | | | |
| | identified sectors/markets | | | | | |
| 8-1 | Evaluate Knowledge | 0.03 | 0.25 | 0.75 | 0 | 0 |
| | products/services to improve | | | | | |
| | performance, derive new | | | | | |
| | products to 0support future | | | | | |
| | demands of other sectors/ | | | | | |
| | markets | | | | | |
| | Total | 1 | 17.25 | 97.25 | 5 | 14 |

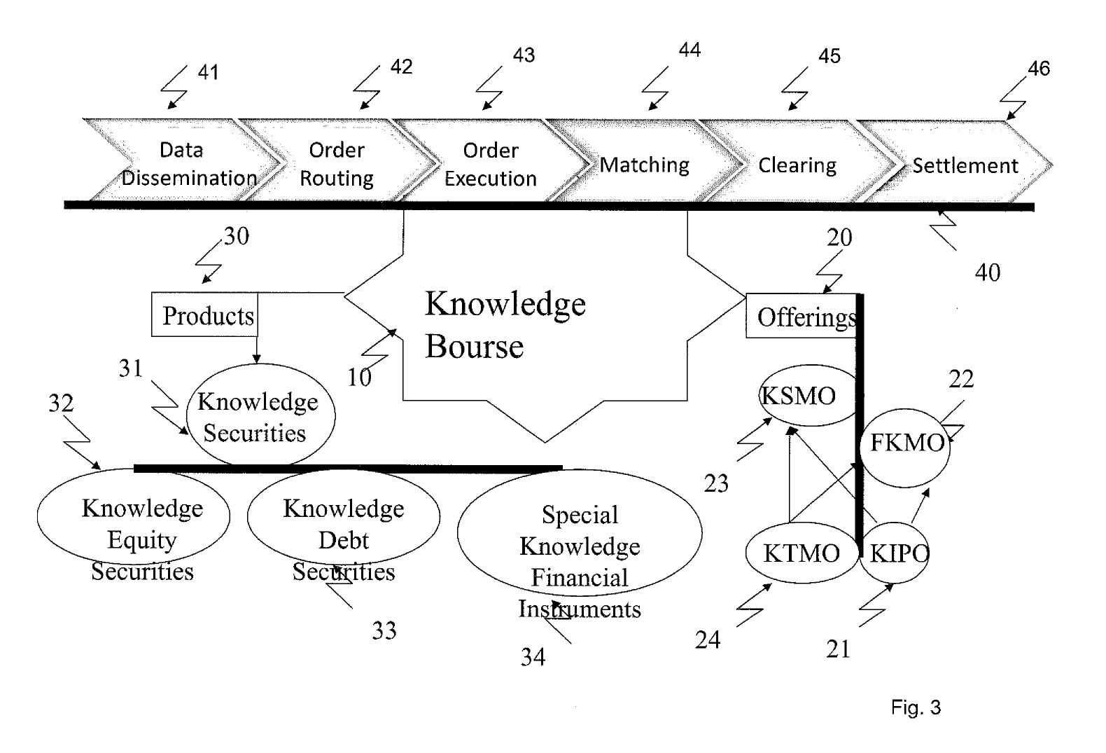

FIG. 3 shows the skeletal structure or architecture of a knowledge bourse that resembles traditional exchange markets with appropriate modifications in accordance with exemplary embodiments of the present disclosure. In the Knowledge Bourse (KB) 10, the Knowledge Market Offerings (KMO) 20 includes Knowledge Initial Public Offering (KIPO) 21, Follow-on Knowledge Market Offering (FKMO) 22, Secondary Knowledge Market Offering (SKMO) 23 and Transfer Knowledge Market Offering (TKMO) 24. KIPO 21 is one form of common stock or shares issued to the public for the first time directly to investors and offered to the primary market by a knowledge-based organization, such as:
A knowledge-based small business just passing the incubation stage and launching its business through a first entry in the marketplace by a newly developed knowledge product.
A small, young knowledge-based company that has been issued a patent or a copyright with high potential of realization as knowledge product/products greatly needed in the marketplace and seeking funds for launching the anticipated knowledge product/products.
A small, young knowledge-based organization seeking capital to expand in a highly speculative market.
A newly founded investment academic institution that has acquired accreditation of all or some of its academic programs.
A large privately owned knowledge-based organization, which has been around for many years and is looking to become publicly traded; such as a private research university with great revenue from intellectual property and/or lease of real physical property.
A knowledge-based organization going through a transitory growth period, and is therefore subject to additional uncertainty regarding its future value.
A publicly traded company desirous of issuing stock for a knowledge-based subsidiary or an R&D arm without having a claim on the assets of the parent company.

The issuer of KIPO 21 seeks the assistance of an underwriting firm in determination of the type of security to issue (common stock or preferred stock), the best offering price and the time to bring it to market as well as the development of the business prospectus of the knowledge-based organization that includes an assessment of the risk associated with the KIPO 21. Unless the knowledge-based organization issuing the KIPO 21 is a well-established knowledge-based entity, there is often little or no historical data with which to analyze its performance. Usually the stature and experience of the board of directors and other actors affecting the business are considered in assessment. In the case of a knowledge-based organization vis-à-vis a commercial entity, the involvement of prominent personnel, such as Noble Laureates or similar figures, is expected to affect the risk and price levels of their security offerings. However, there is no way to predict what the stocks or shares will do on their initial day of trading.

Because KIPO 21 is the main entry of knowledge-based organizations in a newly formed KB 10, KIPO 21 can generally become a turning point in the performance of a knowledge-based company through immediate improvement of financial conditions, increasing opportunities for future financing by raising additional equity capital on favorable terms due to the improved debt-to-worth ratio and by selling knowledge shares to the public as well as gaining public recognition through knowledge stock listing at the KB 10 and attracting the watchful eyes of the financial press. KIPO 21 helps knowledge-based organizations accelerate growth through launching new knowledge products, expanding market share, entering new markets, attracting valuable employees, and retaining key employees. This is in addition to enhancement of the financial position of the knowledge-based organizations in the market due to the higher compounded earnings compared with other types of private finance, less dilution of ownership, and no interest and cash drain of debt financing. The additional moneys derived from the KIPO 21 and the readily marketable unissued knowledge equity shares provide a greater potential for a company's mergers and acquisitions.

A shareholder would benefit as well from KIPO 21 through diversification of the shareholders' portfolio through secondary offerings of knowledge shares in addition to the primary offering of new knowledge shares. In spite of the risk associated with KIPO 21, investors would generally be willing to pay more for public knowledge-based organizations because knowledge shares will be easy to market, knowledge-based organizations will be perceived as mature and sophisticated, and the availability of detailed information on the knowledge-based organizations. The potential increase of knowledge stock is likely to increase shareholder value.

KFMO 22 is a stock issue that follows a KIPO 21 comprising primary and/or secondary shares. A knowledge-based firm may authorize additional shares to be issued at a higher price following a successful KIPO 21. Institutional buyers usually take the opportunity of buying shares from secondary markets in order to increase their shareholdings, thereby gaining control over the issuing company.

KSMO 23 is a registered offering of a large block of a security that has been previously issued to the public and is initially sold through the primary market. KSMO 23 is not dilutive to existing shareholder holdings since no new shares are created and do not directly benefit the issuing company. KSMO 23 is common in the years following a KIPO 21, after the termination of the lock-up period. Typically, owners of closely held companies sell shares to loosen their position and, usually, to gradually increase the share float for the purpose of selling more equity in the company and to void plummeting the share price as a result of high selling volume.

KTMO 24 refers to those securities that may transfer from a traditional exchange market to the KB 10 to benefit from the special nature of the KB 10 or to join a group of other knowledge-based companies.

Typical knowledge financial products 30 of the Knowledge Bourse (KB) 10 consist of a variety of Knowledge Securities 30 as fungible, negotiable instruments representing financial values issued by a knowledge-based organization. Professional stockbrokers conduct trading of the knowledge security in the KB 10 as any other traditional exchange market. Knowledge Securities 31 comprise Knowledge Equity Securities 32 that represents an ownership interest in a knowledge-based corporation and Knowledge Debt Securities 33. This is in addition to Special Knowledge Financial Instruments 34.

The architecture 40 of the Knowledge Bourse 10 is outlined in FIG. 3 and it represents a full set of rules governing the activities associated with the Knowledge Bourse value chain. Data Dissemination 41 is the act of transmitting pre-and-post trade data about quotes and trades respectively to market participants. Order Routing 42 is the act of delivering orders from their originators, such as investors and financial intermediaries, to the execution mechanism. Order Execution 43 is the process whereby orders can be transformed into trades. Matching 44 is the act of a third-party broker matching buyers with sellers within the stock market. Based on the needs of the buyer, the broker finds the right stock for the buyer to invest in. Clearing 45 is an entity of the stock exchange through which settlement of equities happens. The details of all transactions performed by the brokers are made available to the Clearing House by the Stock Exchange. The Clearing House gives an obligation report to Brokers and Custodians who are required to settle their money/securities obligations with the specified deadlines, failing which they are required to pay penalties. This obligation report serves as statement of mutual contentment. The Settlement 46 is what happens after a broker has bought or sold shares. There are two aspects to the settlement: transfer of ownership (i.e., the delivery of what has been bought and sold) and the payment for the shares or other security. Settlement cycle is the period for which equities are traded in Exchange. At the end of this settlement cycle period, the obligations of each broker is calculated and the brokers then settle their respective obligations according to guidelines, laws and regulations institutionalized by the Clearing agency.

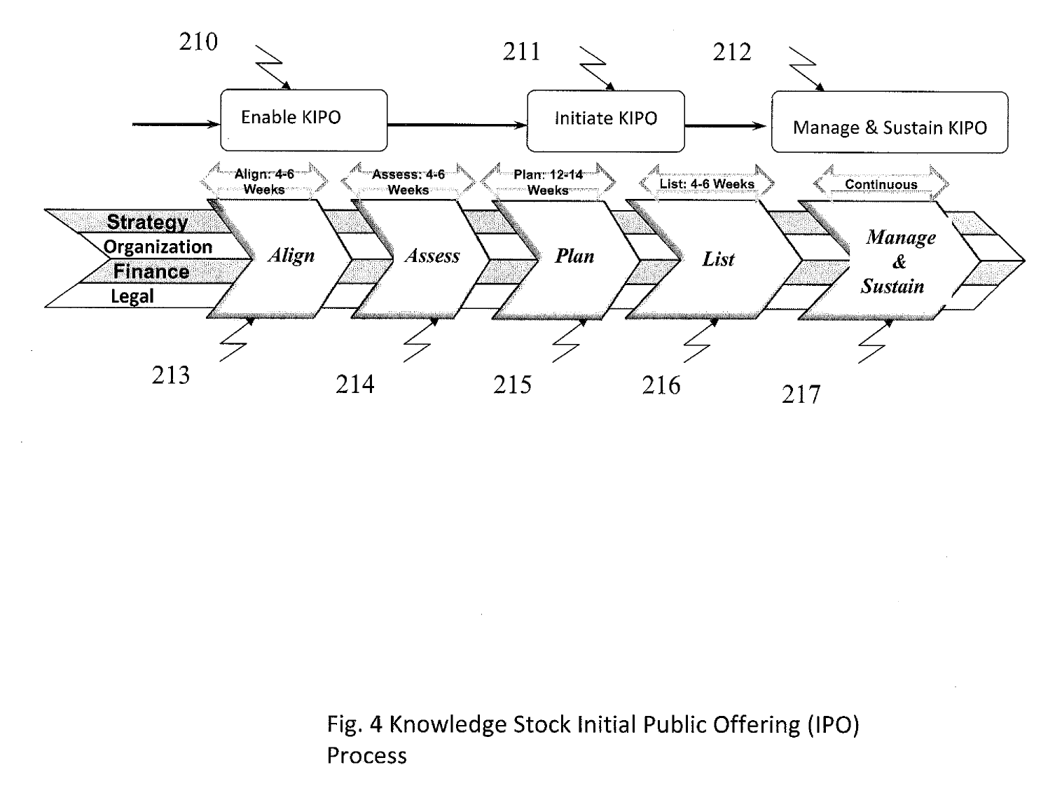

FIG. 4 shows the process of knowledge initial public offering (KIPO) issuance and maintenance in accordance with an exemplary embodiment of the present disclosure. The KIPO 21 process shown in FIG. 4 comprises three major actions: enable KIPO 210, initiate KIPO 211, and manage and sustain KIPO 212. More specifically, the process comprises several actions: First, align 213 takes from 4 to 6 weeks and involves creation of a winning team that comprises 3 core teams, namely (1) Internal Team: company's executive management team (CEO, CFO, and/or COO) that will represent the company to the financial community. (2) Board of Directors: Individuals elected by the corporation shareholders to oversee management of the corporation and bring specialized proven expertise and an independent perspective. The board is comprised of both independent directors and a corporate management director (CEO). The board forms specialized committees to be able to function effectively and efficiently covering audit, compensation, executive, and finance committee; (3) External Advisory Team, including legal and underwriters advisors. The align 213 strategy comprises the step of success definition wherein the core teams get together and step back to brainstorm and answer the questions, such as: What are we trying to do with this business? Why we are considering the option of going to the public market? What is really important to us? How do you define success? What are the critical success factors?

The align 213 step involves development of the knowledge based-company's business strategy: (Where are we today? Where are we going with our business, How will we get there?) as well as the Stakeholder strategy, such as development of a coherent and credible story why the company is raising funds and what the company will do with the proceeds to communicate with underwriters, investors and employees.

Assess 214 comprises:
Assessment of current versus future state of the knowledge-based organization in terms of appropriateness for a public company. The state includes current corporate, capital and management structures; transactions or arrangements with owners and managers and contractual obligations; written contracts, employment agreements and contracts; stock record accuracy; and adequacy of transactions documentation. Assess 214 may involve performance of a legal audit, including employment, stock option or purchase plans, debt and lease agreements, shareholder or management loans, right of first refusal, corporate charter and bylaws, major supply contracts and internal control systems and their capabilities to deliver information the regulator require.
Identification of Gaps between Current and Future State: For example, the following questions can be considered: What changes are required? Should additional shares be authorized? Should the capital structure be changed? Should the stock be split before company goes public? Should affiliated companies be combined? Should the article of incorporation or bylaws be amended? Should a stock option plan be implemented?
Assessment of Barriers to IPO Process & develop risk mitigation approach.
Definition of metrics for future vision.
Identification of benefits and costs of IPO process.
Development of KIPO value proposition/business case.

Plan 215 comprises:
Develop Business Plan. Topics that can be covered in Business Plan include:
   Executive Summary: A brief summary that explains company's story and why a potential investor should make an investment in the business.
   Company Summary: An overview of the business and the key competencies that differentiate the company from its competitors.
   Service & Products: A description of your products/services from customer's perspective, highlighting competitive advantages, product lifecycle, R&D that yielded a competitive edge.
   Market Analysis: A description of your industry, target markets, competitors, and outlook for the future.
   Marketing and Sales Strategies: Analysis of strategies for business growth and achievement of sales targets.
   Operating Techniques and Strategies: Overview of production and service delivery capabilities, current advantages and future opportunities for improvements describing how delivery of services/products to your customer compares to your competitors.
   Management & Ownership: An overview of key managers, plans for adding new members to the management team, current ownership and structure and board of directors.
   Financing Requirements: A summary of the company's current capital structure, short and long term financial needs, plan for using proceeds from new financing sources.
   Financial History and Projections: Historical financial statements for the past 3-5 years, and projections for the coming 3-5 years.
   Appendices/Exhibits.
Identify the tasks to be completed based on: Company assessment, IPO Process Elements, and business plan.
Develop Work Breakdown Structure (WBS).
Identify task owners, budgets and planned completion dates.
Develop a tax plan that covers: How the IPO will affect the owners/managers financial situation? What is the pre-IPO tax and personal financial plan? How do owners/managers minimize income tax liability and how to protect assets? What are the legal techniques that allow stockholders to avoid or defer taxes when the company goes public?
Develop a campaign plan to create a new company image: Hire a public relations firm or consult with advertising agency; Identify new stakeholders (Investors, public, financial institutions); Identify means of communication (trade publications, press, media . . . ); Develop messages based on the Stakeholder Strategy.
Develop Financial Reporting Plan:
   Review and update accounting policies to conform with those commonly used by public companies.
   Prepare effective and timely internal financial reporting system, including skilled personnel and reliable systems, to provide required financial data.
   Plan and implement a process of how the internal reporting systems roll up information and report it to the top management.
   Prepare a system of internal controls.
   Prepare a financial statement for the years the company has been in existence (1 to 3 years):
      Audited balance sheets as of the end of each of the past 1-2 fiscal years.
      Audited statements of income, cash flows, and shareholders' equity for the past 2-3 years.
      Unaudited interim financial statements for the past 3-9 month.
Develop investment plan that considers questions such as: What is the plan of investing cash by selling stock in the public knowledge stock market? What is the best way to get the return needed with affordable amount of risk? What is the investment diversification strategy? Does the compensation plan need to be reexamined? Should a stock option plan be implemented? Should additional options be granted under existing plans?
Plan for Audit Requirements: Assign an independent auditor to review financial statements and accounting practices used and its conformance with those being used by public companies; Make sure that Auditors are familiar with the company history, including the details about the acquisitions, mergers, and investment over the past 3-5 years and identify the gaps that need to be addressed before the IPO.
Anticipate the needs of underwriters and coordinate with auditors to prepare for these requirements.
Timely Disclosure and Public Relations: Designate an information officer and prepare and issue press releases to disclose material information to the public.
Plan and implement internal forecasting and budgeting processes and systems to meet the needs and expectations of the underwriters.
Plan, collect and understand the performance expectations and demands of the market benchmarks.
Review last minutes changes in capitalization: For example, debt or redeemable preferred stock that converts to common stock and changes in capital structure resulting from a change in business legal form or tax status.

List 216 involves:
Draft registration statement.
Prepare presentations for future road shows to tell the story to the people who will help sell the company's securities, people who influence prospective investors (analysts) and to key prospective investors.
All Hands Meting #01: Hold the first “all hands” meeting to be attended by all members of the working group, including company executives, attorneys, auditors, underwriters, and underwriters' attorneys to discuss: terms of the offering, registration form draft, and financial statements requirements.
After the meeting, the company counsel prepares a very detailed timetable, assign responsibilities and due date for the preparation of various parts of the registration statement and completion of numerous tasks.
Draft nonbinding letter of intent between the company and the lead underwriter to confirm the nature of underwriting, underwriter's compensation, number of share or the amount of securities expected to be issued and the anticipated price.
All Hands Meeting #02: Hold the second working group meeting to review the initial draft of the registration statement after the attorneys have consolidated all the inputs of different sections received. The members review the draft and agree on revisions.
All Hands Meting #03: The third working group meeting will be held to review a printer's proof of the registration statement and execute signature pages.
Filing: File the initial registration statement with the appropriate authorities.
Road Show Company Executives and managing underwriters start the road show to meet with perspective investors to discuss the company and the offering.
All Hands Meting #04: All members meet to address and review authorities' comments and approve amendments to the registration statement and finalize pricing.
Filing: File the final registration statement with the appropriate authorities.
Closing: Authority declares that the registration statement is effective, and issues the proceeds of the offering to the underwriters and the company. At closing, documents are executed and exchanged.
Listing: List the company on the Knowledge Bourse or take securities over the counter.

Manage and Sustain 218 involves:
Price Stabilization and overallotments. During the initial trading period, the underwriter may engage in certain stabilizing transactions to guard against sudden downward pressure on stock price caused by speculators.
Periodic reporting. Prepare required quarterly and annual financial reports.
Balancing short term profits and long term growth.
Completing initiatives on time and on budget.
Meeting or exceeding market expectations. Under promise and over deliver, maintain focus by continuously managing business diligently, mange the company and produce results.
Managing internal investors. Ensure that internal investors are thoroughly informed about insider trading rules and the policies for handling these rules, and blackout periods.

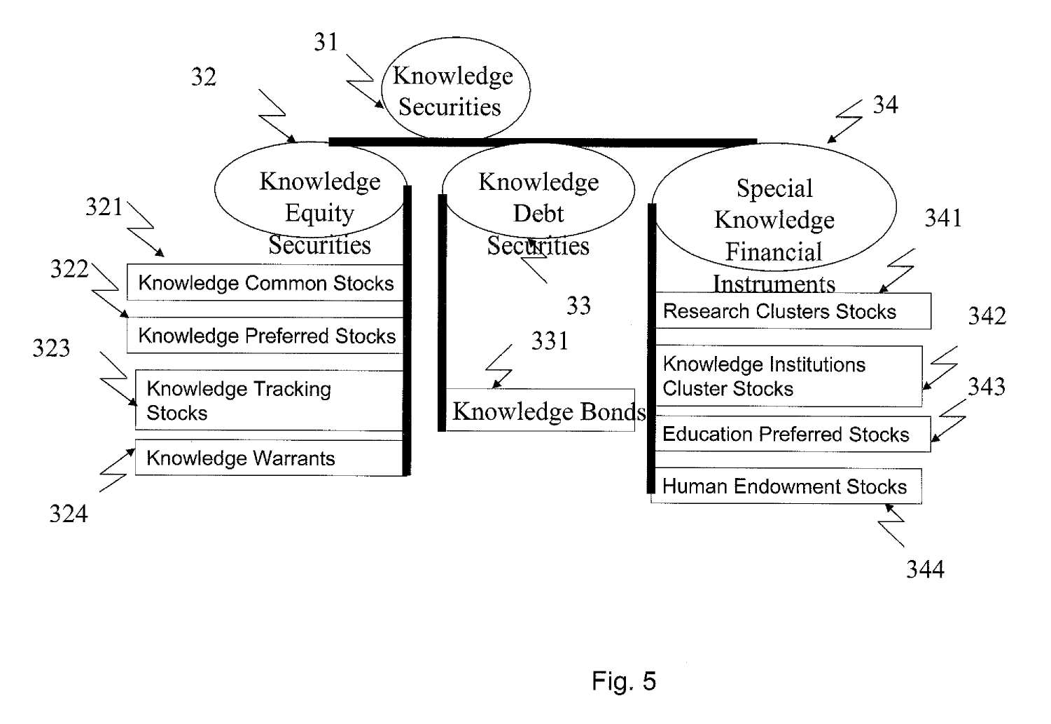

FIG. 5 shows details of knowledge securities traded in the knowledge bourse of FIG. 3, including special knowledge financial instruments, in accordance with an exemplary embodiment of the present disclosure. As shown in FIG. 5, Knowledge Equity Securities 32 comprise Knowledge Common Stocks 321, Knowledge Preferred Stocks 322, Knowledge Tracking Stocks 323, and Knowledge Warrants 324. This stock variety represents an ownership interest in a publicly traded knowledge-based corporation or institution looking for future growth, and requires money to invest to transfer knowledge into a final usable and profitable knowledge product/service. A share of knowledge stock represents ownership in a knowledge-based corporation or institution and is evidenced by stock certificate. For a newly listed knowledge-based company, the stock price is estimated by the issuing entity as the offering price. For an existing publicly traded knowledge-based company, the price at which additional equity is issued is usually based on the current market price. The number of knowledge stock shares a knowledge-based company sells depends on the amount of equity capital the knowledge-based company requires and the price of each share it sells.

Knowledge Common Stocks 321 are knowledge Securities representing equity ownership in a knowledge-based corporation, entitling the holder voting rights and a share of the company's success through dividends and/or capital appreciation. For a publicly traded knowledge-based firm to raise equity it issues Knowledge Common Stocks at a price the market can bear. In the event of liquidation, knowledge common stockholders will have rights in the knowledge-based company's assets only after bondholders, other debt holders, and preferred stockholders have been satisfied.

Like knowledge common stocks 321, Knowledge Preferred Stocks 322 represent partial ownership in a company with no voting rights. However, Knowledge Preferred Stocks 322 earn fixed dividend that is paid before any dividends are paid to Knowledge Common Stock 321 holders and that dividend does not fluctuate. The company does not have to pay this dividend if it lacks the financial ability to do so. Knowledge Preferred Stocks 322 will take precedence over Knowledge Common Stocks 321 in the event of liquidation.

Knowledge Tracking Stocks 323 are a special class of common stocks issued by a parent company that track the performance of a particular knowledge product/service without having claim on the assets of the division or the parent company. When a parent company issues a knowledge tracking stock, all revenues and expenses of the applicable knowledge product/service are separated from the parent company's financial statements and bound to the Knowledge Tracking Stock 323. Knowledge Tracking Stocks 323 trade as separate securities. As a result, if the unit or division does well, the value of the tracking stock may increase—even if the company as a whole performs poorly; the opposite may also be true. Knowledge Tracking Stocks will make it easier for companies to raise capital for specific knowledge product/service instead of spinning off the line of business into a separate company. Keeping companies together allows management to take advantage of any synergies and efficiencies. Managing two classes of stocks with one set of assets needs specific controls in place to avoid conflicts for corporate managers and directors.

Knowledge Warrants 324 are a security issued by a company that provides the holder with the right to buy a share of stock in the company at a fixed price during the life of the warrant. The advantages of warrants are that they are priced based on the implied volatility assigned to the underlying stock—the greater the volatility, the greater the value. Warrants by themselves create no financial obligations at the time of issue. Consequently, issuing warrants is a good way for a high-growth firm to raise funds, especially when current cash flows are low or negative. Warrants do not create any new additional shares currently while they raise equity investment funds for current use.

Knowledge Debt Securities 33 constitute any debt instrument that can be bought or sold between two parties and has basic terms defined, such as notional amount (amount borrowed), interest rate and maturity/renewal date. Debt securities include Knowledge corporate Bonds 331. The interest rate on a debt security is largely determined by the perceived repayment ability of the borrower; higher risks of payment default almost always lead to higher interest rates to borrow capital. Most debt securities are traded over-the-counter, with much of the trading now conducted electronically. Knowledge Debt securities 33 on the whole are safer investments than equity securities, but riskier than cash. Debt securities get their measure of safety by having a principal amount that is returned to the lender at the maturity date or upon the sale of the security. They are typically classified and grouped by their level of default risk, the type of issuer, and income payment cycles.

Knowledge Bonds 331 are a debt instrument issued for a period of more than one year with the purpose of raising capital by borrowing. Generally, a Knowledge bond 331 is a promise to repay the principal along with interest (coupons) on a specified date (maturity). Some bonds do not pay interest, but all bonds require a repayment of principal. When an investor buys a bond, he/she becomes a creditor of the issuer. However, the buyer does not gain any kind of ownership rights to the issuer, unlike in the case of equities. On the hand, a bond holder has a greater claim on an issuer's income than a shareholder in the case of financial distress.

Special Knowledge Financial Instruments 34 in FIG. 5 comprise Research Cluster Stocks 341, Knowledge Institutions Cluster Stocks 342, Education Preferred Stocks 343, and Endowment Stocks 344. The Research Cluster Stock 341 is a special stock wherein the instrument is used to finance a bundle of R&D projects at different stages of knowledge maturity wherein the mix provides an acceptable level of risk and guarantees long term growth in terms of bringing successive knowledge-based products to the marketplace and continuously transforming bleeding edge technologies to leading edge technologies.

Knowledge Institutions Cluster Stocks 342 is similar to the Research Cluster Stock 341 with the difference that the cluster is formed by multiple institutions engaged in transfer of technology from basic and applied research to leading edge technologies, thus generating royalties on intellectual properties.

Education Preferred Stocks 343 are equity securities and private investment in higher education and private research universities. The Human Endowment Stocks 344 are stocks invested in notable scholars and scientists in R&D institutions whose presence attracts public and private R&D funds to research institutions.

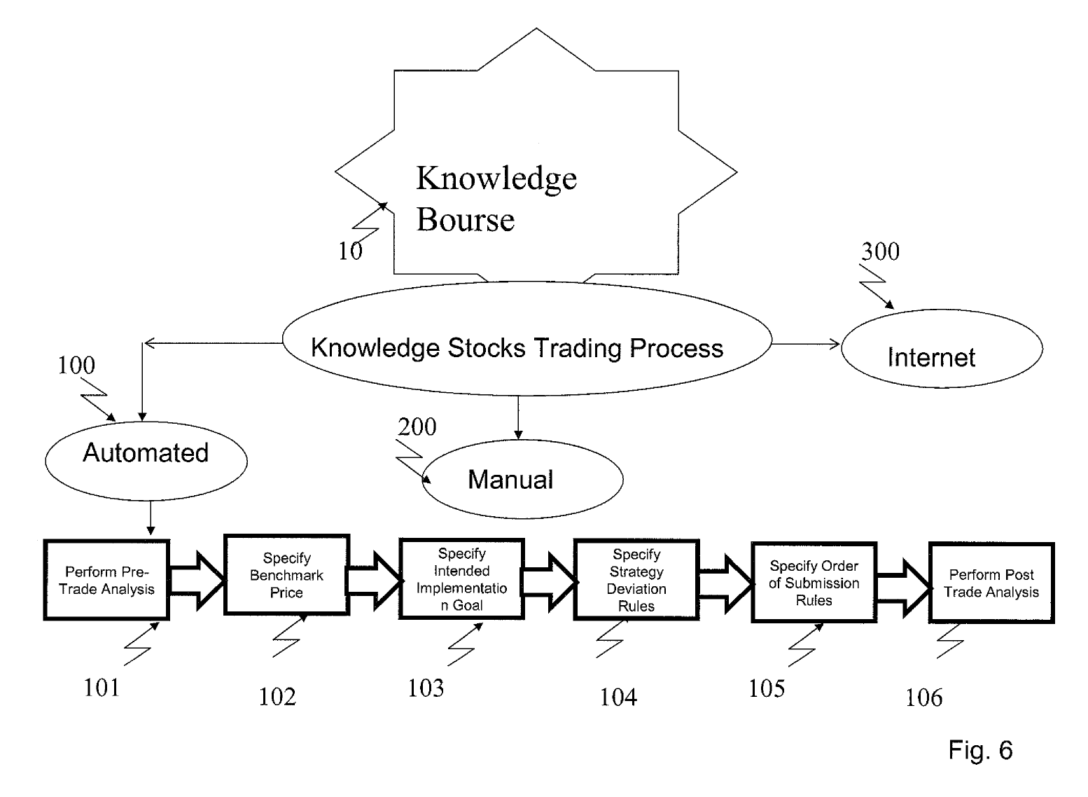

FIG. 6 depicts the Knowledge Stocks Automated trading process in the knowledge bourse in accordance with an exemplary embodiment of the present disclosure. The flow of the Knowledge Securities Trading in the Knowledge Bourse 10 is shown in FIG. 6, wherein the trading is Automatic 100, Manual 200, or Internet 300.

Generally, some traders—especially those with good intuition about the market—will prefer to adopt their own trading strategies based on comprehensive research about the market and trade manually. However, the quickest way for a novice to learn about the market is to engage in manual trading 200, which enables a trader to open or close his market position whenever he chooses.

The most obvious benefit of automated trading 100 is that it frees traders from time constraints by making the practice of constantly watching the market unnecessary. If a change in the market occurs when a trader is indisposed, the automated trading system will execute the buy and sell orders that have been specified earlier. Furthermore, automated trading prevents fear and greed from affecting traders' decisions. In automated trading, however, computer algorithms replace the human element.

In Knowledge Bourse 10, an automated trading 100 makes use of computer programs for entering trading orders with the computer algorithm deciding on aspects of the order such as the timing, price, or quantity of the order, or in many cases initiating the order without human intervention. In addition, automated trading is likely to be used by institutional traders to divide large trades into several smaller trades in order to manage market impact and risk.

In Knowledge Bourse 10, Knowledge Stock traders need to become more proactive to ensure that the underlying algorithmic strategy is consistent with their investment objectives. The automated trading process 100 comprises several steps, including Pre-trade Analysis 101, which provides the necessary data to make informed algorithmic trading decisions as well as insight into potential risk reduction and hedging opportunities to further improve execution. Pre-trade Analysis 100 also provides investors with liquidity summaries, cost & risk estimates, as well as trading difficulty and stability measures to determine which orders can be successfully implemented via algorithmic trading, and which orders require manual intervention in addition to the necessary data to develop views for short-term price movement and market conditions.

A second step in the automated trading process 100 is to Specify Benchmark Price 102. The benchmark price is investor specific. Furthermore, the same investor may specify different benchmark prices for identical orders on different days if the investment objectives have changed and can be categorized into pre-, intra-, and post-trade prices.
The pre-trade benchmark prices are those prices that are known before or at the time trading begins. These include the investment decision price, previous night's closing price, opening price, and arrival price.
Intra-day benchmarks are comprised of those prices that occur during trading.
Post-trade benchmarks include any price that occurs after or at the end of trading, the most common of which being the day's closing price.

A third step in the automated trading process 100 is to Specify Intended Implementation Goal 103, which relates to the level of trading aggressiveness or passiveness. Aggressive trading is associated with higher cost and less risk while passive trading is associated with lower market impact and higher risk. This market phenomenon gives rise to the trader's dilemma: trading too aggressive will lead to higher impact cost, but trading too passively will lead to higher risk and may result in even more costly trades. Therefore, the implementation goal is to solve the trader's dilemma. The solution is found by balancing the tradeoff between cost and risk based at the investor specified level of risk aversion. The benchmark price is investor specific and may in fact be different for two investors with identical trade lists. For example, a value manager may desire execution at their decision price (i.e., the price used in the portfolio construction phase), a mutual fund manager may desire execution at the closing price to coincide with valuation of the fund, and an indexer may desire execution that achieves on different days if the investment objectives have changed.

Another step in the automated trading process 100 is to Specify Strategy Deviation Rules 104 which defines how the algorithm should deviate from the originally prescribed optimal strategy and implementation goal. In specifying the appropriate deviation strategy, it is important to have a complete understanding of how the deviation rule impacts the cost distribution. In times of adverse momentum, the deviation strategy may be more costly than a strategy without any specified deviation rule. Additionally, it is possible to develop deviation rules that further minimize the potential for large losses with an increase in potential for gains, but this comes at an increased cost. It is essential that traders understand the impact of the decision on the cost distribution.

In the automated trading process 100 it is necessary to Specify Order of Submission Rules 105 that refer to the actual market pricing schemes (e.g., market or limit order), share quantities, wait period between order submissions, revisions, and cancellation. The more common pricing rules include market and limit orders (all variations) as well as floating prices that are pegged to a reference price such as the bid, ask, or mid-point and change with reference price. Varying these order types allows the algorithm to adhere to the optimally prescribed strategy by executing aggressively (i.e., market orders) and/or passively (i.e., limit orders) when needed. The use of an algorithm when submitting marketable orders affords a degree of anonymity and does not highlight the type of order being entered. In most situations it is appropriate to combine limit, market, floats and reserve orders.

The automatic trading 100 also involves Perform Post Trade Analysis 106. Algorithmic post trade analysis is a two part process that consists of cost measurement and algorithm performance analysis: Cost is measured as the difference between the actual realized execution price and the specified benchmark price. This allows investors to critique the accuracy of the trading cost model to improve future cost estimates and macro strategy decisions, and it provides managers with higher quality price information to improve investment decisions. Algorithmic performance is analyzed to assess the ability of the algorithm to adhere to the optimally prescribed strategy, its ability to achieve fair and reasonable prices, and determine if the algorithm deviates from the optimally specified strategy in an appropriate manner. Investors must continuously perform post-trade analysis to ensure brokers are delivering as advertised and question those executions that are out of line with pre-trade cost estimates.

The Internet trading 300 will afford special provisions especially for educational and research institutions to perform specific trading functions on the Internet as far as Special Knowledge Financial Instruments are concerned.

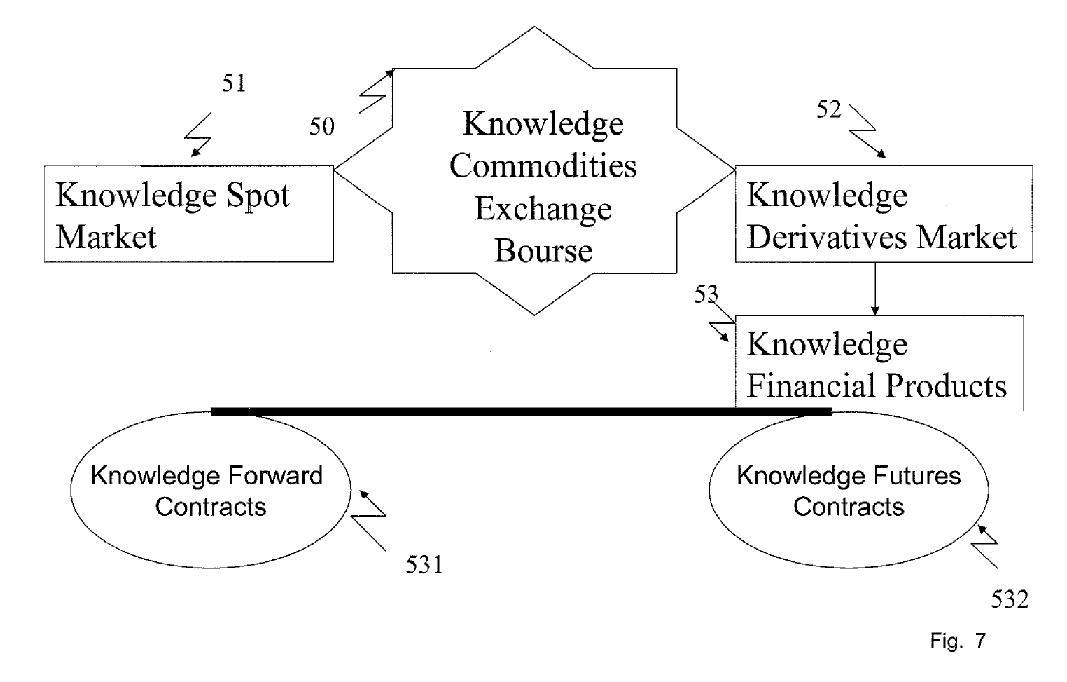

FIG. 7 shows the skeletal structure or architecture of a knowledge commodities exchange bourse that resembles traditional commodities exchange markets with appropriate modifications in accordance with exemplary embodiments of the present disclosure. Exemplary embodiments provide that the functions of the Knowledge Commodity Exchange Bourse 50 are illustrated in knowledge commodity exchange as shown in FIG. 7. Knowledge Commodities are knowledge products/services which have been proven to have a value in the past, need to transfer the ownership to new ownership to continue using it in the same way or create a new use to it. Furthermore, knowledge Commodities are goods for which there is demand, and are supplied without qualitative differentiation across a market.

The Knowledge Commodity Exchange Bourse 50 facilitates trading in various knowledge commodities through a spot or a derivatives market. In a Knowledge Spot Market 51, Knowledge commodities are bought and sold for immediate delivery. In a Knowledge Derivatives Market 52, various Knowledge Commodity Bourse Financial Products 53 or financial instruments based on commodities are traded. The Knowledge Commodity Bourse Financial Products 53 include Knowledge Commodity Forward Contract 531 and Knowledge Commodity Futures Contracts 532. To maintain the futures prices in line with the spot market, the Bourse 50 will include provisions for settlement of contracts by physical delivery and ensuring that the futures and spot prices coincide during the settlement so that the fair price discovery mechanism is in place.

Knowledge Commodities Spot Trading/Market 51 is any transaction where delivery either takes place immediately, or with a minimum lag between the trade and delivery due to technical constraints. Knowledge Commodities Spot Trading/Market 51 involves visual inspection of the commodity or a sample of the commodity, and is carried out in markets such as wholesale markets. Knowledge Commodities Spot Trading/Market 51 requires the existence of agreed standards so that trades can be made without visual inspection.

The Knowledge Commodity Forward Contract 531 is a non-standardized contract between two parties to buy or sell a knowledge product/service at a specified future time at a price agreed today. Forward contracts 531 are not bourse-traded. It costs nothing to enter a forward contract. The party agreeing to buy the underlying knowledge product/service in the future assumes a long position, and the party agreeing to sell the asset in the future assumes a short position. The price agreed upon is called the delivery price, which is equal to the forward price at the time the contract is entered. Forward contracts can be used to hedge risk, as a means of speculation, or to allow a party to take advantage of a quality of the underlying instrument that is time-sensitive.

The Knowledge Commodity Futures Contract 532 is a standardized contract between two parties to buy or sell a specified knowledge product/service of standardized quantity and quality at a specified future date at a price agreed today (the futures price). The futures contracts are traded on the Knowledge Commodity Exchange Bourse 50. The party agreeing to buy the underlying knowledge product/service in the future assumes a long position, and the party agreeing to sell the knowledge product/service in the future assumes a short position. The price is determined by the instantaneous equilibrium between the forces of supply and demand among competing buy and sell orders on the exchange at the time of the purchase or sale of the contract. The future date is called the delivery date or final settlement date. The official price of the futures contract at the end of a day's trading session on the Knowledge Commodity Exchange Bourse 50 is called the settlement price for that day of business on the Bourse.

The difference between Industrial Commodities and Knowledge Commodities is given in Table 11.

TABLE 11

| | Industrial Commodities | Knowledge Commodities |
|---|---|---|
| Product type | Physical goods | Virtual products |
| Product Examples | Agriculture products and | Operating System Software Disk, |
| | metals | Movie Disk/Tape |
| Design/ Development | Simple | Complex and time-consuming task |
| Production | Each new product will take | Can be copied for almost zero cost |
| Effort/Resources | resources to manufacture it | |
| Trade-off | Between quality and quantity | Between quality and time |
| Production Time | the amount of products | No need to invest time to create |
| | created, is limited by the time | copies of the product, instead, invest |
| | it takes to manufacture each | time into making the product better |
| | product | |

Benefits of Knowledge Commodity Exchange Bourse 50 include:
Transparency and Fair Price Discovery: Trading in Knowledge Commodity futures is transparent and a process of fair price discovery is ensured through large-scale participation. The large participation also reflects views and expectations of a wider section of Knowledge Commodities investors concerned with that commodity.
Online Platform Knowledge Commodities Investors get an online platform for price risk management.
Hedging: Provides a platform for producers to hedge their positions according to their exposure in physical commodity.
No Insider Trading: Dealing in commodities is free from the evils of insider trading. Besides, there are no company specific risks as those seen in stock markets.
Simple Economics; Knowledge Commodity trading is about the simple economics of demand and supply. The greater the demand for a knowledge commodity, the higher its price and vice versa.
Trade on Low Margin: Knowledge commodity futures traders are required to deposit low margins, roughly 5 to 10% of the total value of the contract, much lower compared to other asset classes. The low margin, which again varies across exchanges and commodities, facilitates the taking of large positions at lower capital.
Seasonality Patterns: Provide a clue to both short and long term players.
No Counter-party Risk: Much like the exchanges in the equity market, Commodity Futures market have Clearing Houses, which guarantee that the terms of the contracts are fulfilled, thereby eliminating the counter-party risk.
Wide Participation The emergence of online trading would enable growth in the knowledge commodity market, much akin to the one seen in the equity market. It would also ensure bringing the market closer to both, the user and the trader.
Evolved Pricing The rise in participation would decrease the risk of cartelization, ensuring a holistic view on the knowledge commodity. Hence, pricing would be more practical and less irrational leading to Fair Price Discovery Mechanism.

Investors in the Knowledge Commodities Exchange Market 50 include: Producers, Distributors, Publishers, Importers/Exporters, Knowledge commodity financers, Credit providing agencies, hedgers, speculators, arbitrageurs, large scale consumers. For example, TV stations/networks/cable companies, movie theatre companies, universities, schools, news agencies, PC/hardware manufacturers and corporations having risk exposure in knowledge commodities.

The Knowledge Commodity Exchange Bourse 50 is a public marketplace where knowledge commodities are contracted for purchase or sale at an agreed price for delivery at a specified date. The knowledge commodities purchase and sale, which must be made through a broker who is a member of Knowledge Bourse, are made under the terms and conditions of a standardized futures contract. The knowledge commodity futures bourse deals in standardized contractual agreements. These agreements are called futures contracts and provide for delivery of a specified amount of a particular commodity during a specified future month, but involve no immediate transfer of ownership of the knowledge commodity involved. A two-way auction is continuously during trading hours. This two-way auction is made possible because of the standardized futures contract, which requires no description of what is being offered at the time of sale. Also, the two-way auction is made practicable because the inflow of both buying and selling orders to the exchange floor is normally in sufficient volume to make buying and selling of equal importance.

In the Knowledge Commodity Exchange Bourse 50, the prices of the Knowledge Commodities are determined solely by supply and demand conditions. If there are more buyers than there are sellers, prices will be forced up. If there are more sellers than buyers, prices will be forced down. Buy and sell orders, which originate from all sources and are channeled to the knowledge bourse trading floor for execution, are actually what determine prices. These orders to buy and sell are translated into actual purchases and sales on the knowledge bourse trading floor, and according to regulation must be done by public outcry across the trading ring and not by private negotiation. The prices at which transactions are made are recorded and immediately released for distribution over a vast telecommunications network.

The Knowledge Commodity Exchange Bourse 50 has its own clearing house, where members of the Bourse 50 are required to clear their trades through at the end of each trading session, and to deposit with the clearing house a sum of money (based on clearing house margin requirements) sufficient to cover the member's debit balance. The clearing house is responsible to members for the fulfillment of contracts. The clearing house becomes the “other party” for all future trades between exchange members. This mechanism greatly simplifies knowledge commodities futures trading.

In the Knowledge Commodity Exchange Bourse 50, commodities futures trading provide the means for those who produce knowledge commodities to hedge, or insure, against unpredictable price changes. In any case, the firm would be protected against losses resulting from price fluctuations due to offsetting profits and losses, unless futures prices should fail to advance or decline by the same amount. Usually, however, this price relationship is sufficiently close to make hedging a relatively safe and practical undertaking.

The primary function of the knowledge commodity trader, or speculator, is to assume the risks that are hedged in the futures market. To a certain extent these hedges offset one another, but for the most part speculative traders carry the hedging load. Everyone who trades in knowledge commodities becomes a party to an enforceable, legal contract providing for delivery of a cash commodity. Whether the commodity is finally delivered, or whether the futures contract is subsequently cancelled by an offsetting purchase or sale, is of no real consequence. The futures contract is a legitimate contract tied to an actual knowledge commodity, and those who trade in these contracts perform the economic function of establishing a market price for the knowledge commodity.

In the Knowledge Commodity Exchange Bourse 50, to sell a commodity future short one sells first and then closes out (or covers) this sale with an offsetting purchase at a later date. One need not have, or own, the particular commodity involved. The practice of selling short is common in futures markets. Those who sell short (with the exception of those placing hedges to protect a cash commodity position) do so in the expectation that prices will decline and that they will be able to buy later at a profit. A short position in the market is of course just the opposite of a long position, which involves buying first and closing out (or liquidating) later with an offsetting sale. Conditions of a short sale comprise:
One agrees to deliver what he sells at a later date.
If one does not deliver, he will stand any loss that the buyer may suffer as a result of an advance in price between the time one makes the sale and the time he cancels out his delivery obligation by means of an offsetting purchase.
When one sells a knowledge commodity future short, one does so under these conditions. Of course, if prices decline during the period one is short, then one realizes a profit on the transaction.

In the Knowledge Commodity Exchange Bourse 50, when one establishes a position in a commodity future, either long or short, it is necessary to deposit a sufficient amount of money with the broker to protect the position—this protects the broker against loss in the event the trade is unprofitable. This deposit is referred to as a margin. The margin required of a customer by a broker is a different margin than that required of the broker by the clearing house. The amount of margin that one is required to deposit with the broker in order to trade in knowledge commodities is 10 percent or less of the market price of the commodity. There is no interest charged on the difference between the market value of a futures contract and the margin deposited to trade in it.

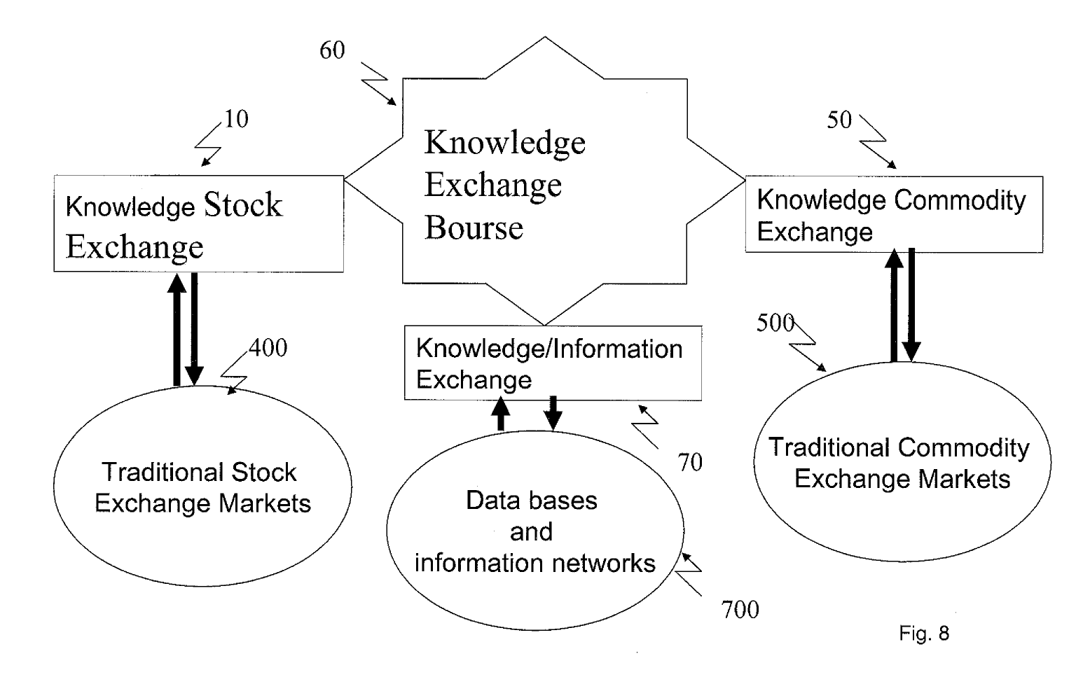

FIG. 8 shows a combination of knowledge securities exchange bourse of FIG. 3 and the knowledge commodities exchange bourse of FIG. 7 in accordance with an exemplary embodiment of the present disclosure. A preferred embodiment is shown in FIG. 8, wherein the Knowledge Commodity Exchange 50 and the Knowledge Stock Exchange 10 are carried in the Knowledge Exchange Bourse 60. Information Exchange 70 can be also carried out wherein some kind of bartering mechanism is used to exchange information for a fee using special software. The Information Exchange 70 will be managed by the Knowledge Exchange Bourse 60 but will have access to readily available information networks and databases 700.

The relationship Knowledge Commodity Exchange 50 and the Knowledge Stock Exchange 10 with the traditional commodity exchange 500 and the traditional stock exchange 400 will be that of competition and collaboration.

Competition Factors that will increase competition between the different branches of the Knowledge Exchange Bourse 60 and the existing stock exchanges 400 and traditional commodity trading markets 500 comprise:
Potential Profits: The possibility of obtaining sufficient profits will provide an incentive for private firms to compete with the Knowledge Exchange Bourse 60 in the provisions of some of its functions.
Diversity of Trading Objectives: A diversity of preference among investors for different trading objectives will give an incentive for market participants to develop different trading systems to satisfy these diverse preferences.
Legal Impediments: The intensity of competition between trading systems may be influenced by the pressure of legal impediments and governmental regulations.
Economics of Scale: Economics of scale arise in the management of trading systems if the cost per trade of operating the system declines as the number of trades executed on the system increase. However, advances in technology have lowered the cost of building trading systems and reduced the cost advantages available to large exchanges as a result of the economics of scale, and make it easier for the new Knowledge Exchange Bourse 60 to enter the market for trading systems. The existing exchanges with high historical costs are at a competitive disadvantage.
Network Externalities: Existing exchanges are likely to benefit from a positive network externality over knowledge Bourse and also a benefit that adds to the users of such network. The likelihood of a trader receiving an execution of his order on an exchange is higher if the other traders already send their orders to the exchange. Order flow attracts the flow of orders, and a trading system with a large number of orders has advantage over a new market.
Enhancements in order routing facilities: Enhancements in the Knowledge Exchange Bourse 60 order routing facilities and the ease of submitting contingent orders to many markets will affect market participants' willingness to establish trading systems that compete with existing exchanges. As the direct switching costs to investors of diverting their order flow away from an existing market to a newly developed Knowledge Bourse become lower, with advances in information technology, so investors become more disposed to consider using Knowledge Bourse as an alternative trading system.

In terms of cooperation among the components of the Knowledge Exchange Bourse 60 and traditional exchange markets, there are many ways in which the Knowledge Exchange Bourse 60 can affect a linkage, joint venture, or merger with another exchange's contractual procedures by which shared delivery of services can be implemented. Any subset of the various functions undertaken by the Knowledge Exchange Bourse 60 and other exchanges can be shared, including Marketing, Listing, Order Routing, Information Dissemination, Order Execution, Matching, Clearing, Settlement, and Administrative Services. Furthermore, there are many aspects common to most cooperative exchange projects including reduction of costs and thus gaining on the average over competitors. For example, economics of scale may be available to both exchanges, linkage between futures markets may reduce the costs of maintaining off-setting positions on both exchanges, and a linkage may also allow cooperating exchanges to benefit from the network externality associated with the attraction of order flow. New technology is important to enhance network externality the exchange may obtain by establishing a market linkage between itself and the Knowledge Exchange Bourse 60, assuming the exchange has a compatible technology. The exchange governance has a role in affecting both market development and success. Difficulty of creating creditable contracting commitments between the cooperating exchanges.

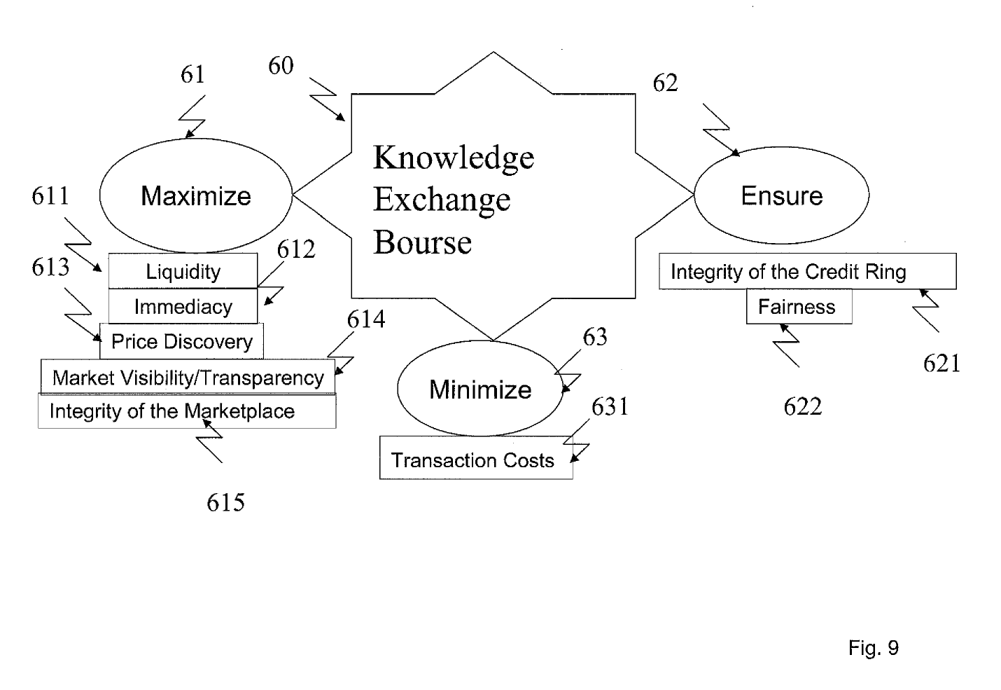

FIG. 9 illustrates strategies of the knowledge exchange bourse in accordance with exemplary embodiments of the present disclosure. The strategies of the Knowledge Exchange Bourse 60 is shown in the graph of FIG. 9 wherein they are founded on three principles—minimize 61, ensure 62, and maximize 63. Application of these principles will cause the structure of the Knowledge Exchange Bourse 60 to blend and balance the service qualities and attributes preferred by each of the marketplace's customer.

In the realm of maximize 61, the first target is market liquidity 611, which is defined as the market's capacity to absorb customers' buy and sell orders at or near the last sale price of a particular security. The greater the capacity to absorb customers' buy and sell orders and the greater the number of orders and volume of shares that orders at or near the last sale price of a market can trade with little or no change in market price, the greater the market's liquidity. The goal of the Knowledge Exchange Bourse 60 is to provide the capability to traders to buy and sell an infinite amount of the asset being traded at the same price number and at the same time without any appreciable delay. The Lack of liquidity in the Knowledge Exchange Bourse 60 will adversely impact the following measures of market quality:
Reported bid/ask prices of securities;
Reported available volume at those prices;
Certainty that orders will be executed at, or near, reported prices;
Transaction costs;
Spread between the bid- and ask-price for a particular security; and
Market's price reaction or volatility to temporary imbalances between buy and sell orders.

Liquidity 611 is affected by the overall Knowledge Exchange Bourse 60 structure. In a consolidated market with all order flow taking place on single marketplace, liquidity is maximized. The guidelines of the Knowledge Exchange Bourse 60 structure are based on the following strategies: Maximize the Depth and Breadth of the Market; Maximize Speed and Maximize Resiliency.
Maximizing the Depth and Breadth of the Market: Depth of the Market is a gauge of the manner in which the spread widens or narrows as the size of a transaction becomes larger. The width of the spread is the difference between the bid and the ask price for small-sized orders. In a deep and broad market, the limit order book will contain a significant number of orders at prices above and below the market price at which a security is currently trading. Further, the orders at any given price level are of substantial aggregate volume and are accordingly sufficiently large to absorb reasonable order flow. The more that limit-orders are exposed for auction, the more visible the market's liquidity, and, in turn, the greater is: The efficiency of the pricing mechanism; The attractiveness of the market to potential buyers and sellers and the assurance that a buyer or seller will obtain the best available price at the time of the trade; and the likelihood that an investor has received best execution.
Maximize Speed: Speed at which orders can be executed, or the expected time market participants need to wait before an order on the other side of the market appears.
Maximize Resiliency: In a resilient market, a security will rebound quickly from sudden price changes. It relates to the dynamic properties of transaction prices, in particular the extent to which transaction prices diverge from and revert to equilibrium prices.

Maximize 61 action also includes Immediacy 612, which refers to how fast an order can be filled, as measured by the amount of time it takes to execute an order at a reasonably acceptable price. The greater the liquidity on the marketplace, the less time it takes to complete a trade. The demand for immediacy arises because at any particular time the number and volume of buy orders at a given price level is unlikely to match the number and volume of sell orders. If an investor wants timely execution of their orders, they will route their orders to the market which best satisfies this demand.

The Maximize 61 action is to be applied to Price Discovery 613 that relates to a market's ability to price a security at the value which the supply and demand of well-informed investors would place on the security. Price discovery is the process by which the execution price for a trade is established. Pricing inefficiencies and inability to properly assess supply and demand may cause investors to lose confidence in the integrity of the aggregate marketplace and begin searching for other markets or mechanisms, or they may choose to invest in different securities or assets altogether. If a market does not price a security at its proper value, the price discovery process is ineffective or inefficient. This result may occur due to:
Large imbalance of knowledge, where some investors are well-informed, but a majority of investors are not;
Faulty exchange's mechanics, where it fails to provide incentives for orders to be shown;
Market manipulation through the dissemination of false information or deceptive trading practices; and
Market lacks visibility.

Effective price discovery process is accomplished through maximizing:
The public disclosure and reporting of orders and trading data;
The degree to which orders consolidate to a central location;
The trading rules governing the way that orders interact; and
The ways in which investment dealers participate in trades.

The Maximize 61 action includes Transparency 614, which refers to the degree to which real-time dissemination of information about orders and trades is made publicly available. The metrics of Transparency are real time dissemination of pre-trade and post-trade information. Without visible depth and breadth of orders in a market, investors and brokers are unable to evaluate supply and demand and current prices on an informed basis.

Furthermore, the Maximize 61 action applies to Integrity of the Marketplace 615 which is defined as the level of general confidence investors and the general public have in an exchange's marketplace. This confidence is closely associated with investors' perception of the market's fairness. The Knowledge Exchange Bourse will establish and enforce effective regulation, market surveillance and enforcement of both market activities and the conduct of its members and their employees concerning:
Trading ethics and procedures;
Standards of conduct for member firms and their employees; and
Proficiency requirements.

Another important action in the strategies of the Knowledge Exchange Bourse 60 is Ensuring 62 that applies to Fairness 621 which is the universal applicability of rules and procedures to all market participants. Accordingly, exemplary embodiments of the Knowledge Exchange Bourse 60 adopt fair and equal treatment for all participants using a set of rules guaranteeing a fair “order displacement” function, whereby existing orders at a given price must be satisfied before a transaction at an inferior price can take place, and where the first order received at a price gets the trade. Regulations of the Knowledge Exchange Bourse 60 will put provisions in place to ensure that all participants operate under essentially the same rules and conditions and in which no individual or group of participants has advantage over others in terms of access to the marketplace, priority of trade execution, or the receipt of market information.

Ensure 62 also applies to Integrity of the Credit Ring 622, which is defined as the certainty with which, once a trade has been executed, the buyer and seller can expect their trade to be settled.

Investors will prefer to trade in Knowledge Exchange Bourse 60 where they are assured that trades will settle to avoid additional costs in the form of determining the creditworthiness and trustworthiness of potential counterparties or losses caused by counterparties who fail to settle. Without such certainty, potential participants will be reluctant to trade in a market because of the risk that the counter-party will not be able to complete the trade. Knowledge Exchange Bourse 60 regulations will ensure that its members should guarantee that trades made on behalf of their clients always settle promptly through margin requirements and capital requirements imposed on members and suitable regulatory oversight.

The Minimize 63 action applies to Transaction Costs 631 that represents the cost of implementing an investor's investment strategy. These costs are important to investors as they directly reduce the net return on investment. Transaction costs are a major factor in determining on which market center investors or brokers will choose to execute trades. Transaction costs 631 may be broken down into a number of categories:
Brokerage commissions and/or dealers' mark-ups;
Member firms' transaction fees;
Facility costs; and
Execution costs.

The Knowledge Exchange Bourse 60 will allow investors to route orders for immediate execution from remote location, execute trades automatically, and report and lock them into clearing for settlement without human intervention to reduce the processing costs. The Knowledge Exchange Bourse 60 will embrace new technologies and implement trades efficiently to minimize the transaction costs.

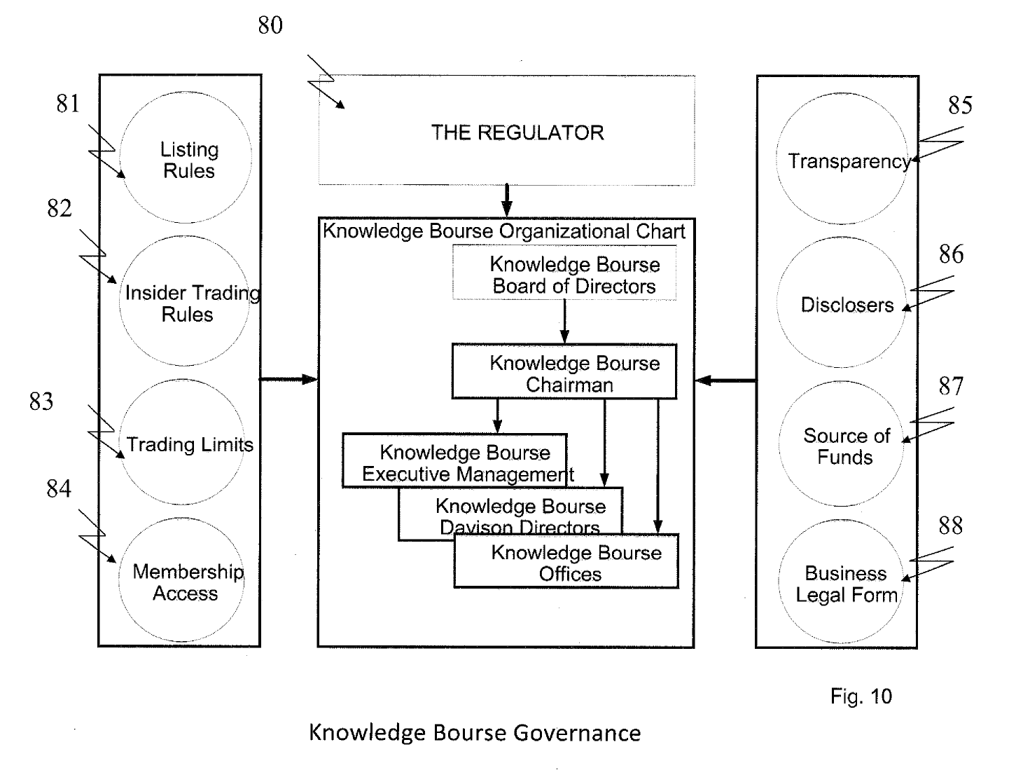

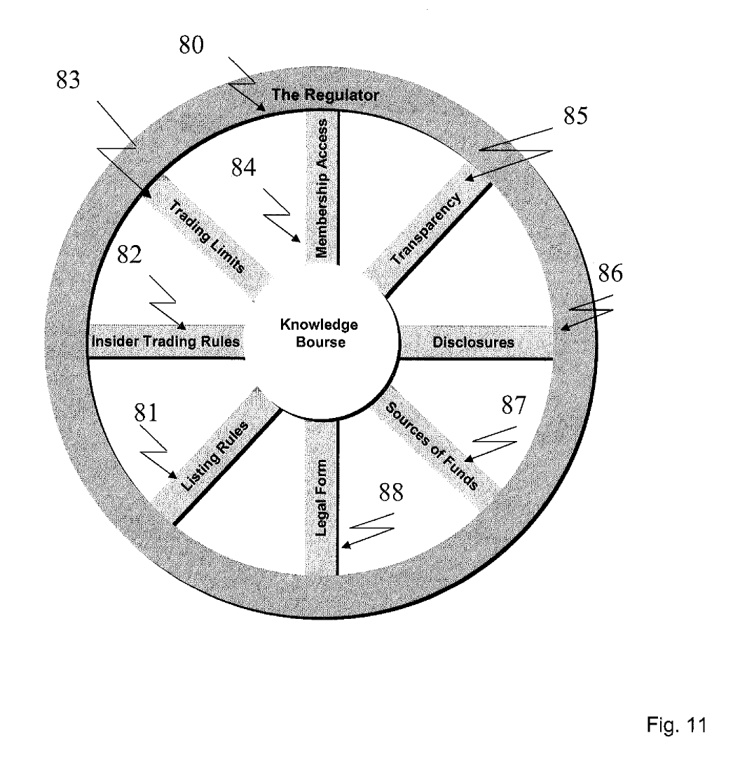

FIG. 10 shows the Governance organization of the knowledge exchange bourse in accordance with exemplary embodiments of the present disclosure; FIG. 11 depicts Governance of the knowledge exchange bourse in accordance with an exemplary embodiment of the present disclosure. The schematic of the Governance of the Knowledge Exchange Bourse 60 is shown in FIG. 10 and FIG. 11. Good governance is a critical ingredient of sound capital markets since it describes the system by which the corporation is directed, controlled and held to account. It is the system by which the legitimacy, relevance and compliance of the corporation is monitored, supervised and regulated It is the self-regulatory mechanisms by which the corporation governs and conducts itself to ensure that it remains legitimate, viable and competitive. The Knowledge Exchange Bourse 60 will adopt a clear and transparent corporate governance framework for which it will provide adequate disclosure.

The issues affecting the Governance of the Knowledge Exchange Bourse 60 include Listing Rules (LR) 81 which comprise a set of regulations applicable to any company listed on the Knowledge Exchange Bourse 60, subject to the oversight of the Regulator 80. The Listing rules will set out mandatory standards for any company wishing to list its shares or securities for sale to the public on the Knowledge Exchange Bourse 60, including principles on executive pay and the requirement to comply or explain noncompliance with the Corporate Governance Code, the requirements of information in a prospectus before an initial public offering of shares, new share offers, rights issues, disclosure of price sensitive information, or takeover bids for companies.

Listing requirements specify the relationship between the Knowledge Exchange Bourse 60 and the issuer, and govern the standards expected of the issuer and its directors. Listing rules are crucial to controlling the standard of disclosure and code of conduct of companies offering public securities. The Regulator 80 and the Knowledge Exchange Bourse 60 will define the responsibilities and obligations of the listing company in connection with the trading of their issued and outstanding securities in the listing market. In cases where the regulator 80 and the Knowledge Exchange Bourse 60 share listing responsibilities, it will be completely clear to market participants where each step in the decision-making process lies, including the ultimate decision in the listing process. Listing rules 81 will be reviewed and approved and standards monitored by the regulator 80.

The Regulator 80 and the Knowledge Exchange Bourse 60 will formulate and publish appropriate listing rules. The respective responsibilities of the Regulator 80 and the Knowledge Exchange Bourse 60 in the listing process will be fully transparent. Requirements such as the listing procedures, time scheduling for processing of the listing dossier, costs for the issuer, and minimum size of capitalization will be compiled in a single rulebook, the “IPO Process Book,” which will be publicly available.

An example of Listing Rules 81, the South African government encourages overseas-controlled companies to seek a listing on the JSE and so provide the public with an opportunity to obtain a stake in the equity of companies trading in South Africa. Applications for listing are made to the Manager (Listings) of the Securities Exchange and must be submitted through a sponsoring broker. A number of requirements must be met before a company's application for a listing will be accepted. The requirements for listing on the main board include the following:
A subscribed capital of at least R1 million in the form of at least 1 million shares in issue.
A holding by the public of at least 30 percent of the first million shares and an agreed percentage of the balance. There should not be fewer than 300 shareholders.
A satisfactory profit history for the past three years with a current audited profit level of at least R1 million before tax. Exceptions are made in special circumstances and in the case of newly formed mining companies.

Required are an approved memorandum and articles of association (articles of incorporation and bylaws) of the parent and any subsidiary companies—no application for a listing will be considered otherwise. These documents must comply with the requirements of the JSE, which are detailed in a booklet published by the Securities Exchange entitled, “Requirements for Memoranda and Articles of Association.” The listing of management, founder, or any other classes of shares ensuring control of a company by a small group of shareholders will not be permitted.

Insider Trading Rules 82 are defined as the rules governing a specific prohibited activity. Insider dealing occurs where a privileged insider, such as an officer or professional adviser who has unpublished, material, price-sensitive information about securities gained by virtue of his relationship with the company, exploits that information to make a profit or avoid a loss by dealing in the securities, the price of which would have been materially altered if the information had been disclosed. The securities regulator 80 normally sets rules to prevent insider trading and market manipulation, and relies on the market to implement the rules. Knowledge Exchange Bourse 60 will set detailed Insider Trading regulations based on the Regulator's rules 80. The Regulator 80 and the Knowledge Exchange Bourse 60 will have at its disposal a variety of sanctions and penalties to be imposed on intermediaries to address improper conduct by market intermediaries. The sanctions and penalties will be used in a proportionate manner, and will be subject to review and appeal via a procedure of due process. The range of sanctions and penalties will cover administrative, civil and criminal remedial measures. Examples of sanctions imposed by the Regulator or the Knowledge Exchange Bourse 60 preferably include:
A warning;
A reprimand in private or by way of public statement;
A fine, as stipulated by law or in a contract with the capital market;
A public statement of censure;
The imposition of conditions on the operations of the firm, its principals, or employees;
The temporary suspension of the member firm or any of its executives from all Knowledge Bourse facilities for a defined period;
The termination of membership of the Knowledge Bourse and dealer association;
A recommendation by the Knowledge Bourse to the Regulator that the license of a member be suspended;
The transmission of the file to the judicial authorities for action under criminal law; and
The termination of the firm's license.

Considering the Trading Limits 83, the Knowledge Exchange Bourse 60 will be protected by the rules that prevent a listed knowledge share from trading on another market or from trading at all off the market (i.e., over the counter). Investors benefit from the disclosure of information about all trades as they occur, and the market's rule ensures this by requiring all trades to take place on the market. Trading on a market is more transparent and better priced than trades off a market. The rule allows a critical mass of shares for trading by consolidating order flow, which makes the bourse more efficient. Listing on many markets would dilute the market for the security.

Regarding the Membership Access 84, the Knowledge Exchange Bourse 60 will be treated as a firm, and will prosper by a strategy that limits access to membership. The Knowledge Exchange Bourse 60 Governance structure will be a Commercial Mutual Nonprofit Firm that is controlled by and run for the consumers of the firm.

Transparency 85 about pricing and volume is critical to a well-functioning Knowledge Exchange Bourse 60. Part of the Knowledge Exchange Bourse 60 will run as an electronic auction market and will publicise all trades immediately. Another part of the Knowledge Bourse will run as a dealer market that will permit a delay for block trades subject to strict rules. Some block trades are so big that a dealer, who reveals or even suggests the large size of the trade before obtaining counter parties, would change the market price of the stock to his or her disadvantage.

The Knowledge Exchange Bourse 60 rules and regulations will be clearly expressed, understandable and readily available to anyone who needs to use them and will be founded on legislative provisions. The Knowledge Exchange Bourse 60 operations will be guided by rules that are founded on well-established practices that are widely understood, clearly expressed and readily available to anyone who needs to use them. The rules of the Knowledge Exchange Bourse 60 will be applied equally to all participants without favor or discrimination.

The Knowledge Exchange Bourse 60 will observe standards of fairness and confidentiality when exercising powers and delegated responsibilities. The Knowledge Exchange Bourse 60 will ensure that the exercise of the self-regulatory power is in the public interest, and results in fair and consistent enforcement of applicable securities laws, and regulations. Knowledge Exchange Bourse 60 rules will include a wide diversity of activities: admission to trading; listing; integrity and conduct in the market; service providers to the market; relationships with customers; complaints, procedures for disputes, and arbitration and discipline. Knowledge Exchange Bourse 60 rules will ensure a high standard of conduct in the following fields: licensing; surveillance; enforcement and discipline; standards of integrity for broker-dealers and other market participants; and conduct of business of firms.

In terms of Disclosures 86 (FIG. 11), the Knowledge Exchange Bourse 60 regulations/procedures will address several questions: What must be disclosed? How specific must the disclosure be? How is the information disclosed? Who frames and enforces the disclosure rules? It will be required to balance the shareholder's need for transparency against the issuer's cost of supplying the information. Assembling the data, publishing it, distributing it, and keeping it up to date is expensive.

The Regulator 80 may elect to reduce the cost to the listed company and accept that the investor will be less protected. The Knowledge Exchange Bourse 60 has an important role to play in ensuring that companies adhere to high quality standards of financial disclosure. Material information about corporate events and actions must be disclosed to the public on an ongoing basis, and made available as soon as is feasible. The Knowledge Exchange Bourse 60 will require issuers to have a high-quality financial reporting infrastructure and prepare their annual accounts in accordance with high quality standards for accounting such as the International Accounting Standards Committee (IASC), the International Organization for Securities Commissions (IOSCO) and other organizations. The Knowledge Exchange Bourse 60 will require issuers to use auditing procedures based on standards of a high and internationally acceptable quality and there is a mechanism is in place to enforce compliance with accounting and auditing standards. Issuers must keep investors informed on an ongoing basis, largely through periodic financial statements, but also by announcing events and actions that have a material effect on corporate value. In this way, investors and intermediaries are able to assess factors that contribute to the price discovery process, and make informed decisions as to whether they should deal.

Disclosure 86 (to investors) preferably include, but not be limited to material information on: financial and commercial results, company objectives, major share ownership and voting rights, Members of the board, key executives, and their remuneration, Material foreseeable risk factors in the company set in the context of its industry, Material issues regarding employees and other stakeholders, Governance structures, Policies and implementation thereof.

Comparability and reliability of financial information are critical to informed decision-making. The disclosure of financial information include, amongst other things:
Information needed for the ‘due diligence process’ applied to listed companies;
Procedures on how the public and regulatory bodies can obtain disclosure from issuers;
Process needed for information to be made available to the public by issuers;
Issuer's responsibility for compliance with the standards of disclosure;
A statement of continuing obligations that provides a framework for issuers to fulfill their duty to the investing public by keeping the market fully informed at all times; and
The basis on which issuers are bound to observe continuing disclosure obligation.

The following market-based sources of funds 87 for the Knowledge Exchange Bourse 60 are identified:
Fees must not be so great that they discourage issuance and trading of stocks;
Registration fees for issuers;
Periodic registration fees for brokers and dealers;
User fee for brokers and dealers when they use the market;
Listing fee for companies listed on the market;
Periodic ‘franchise tax’ on corporations and other businesses; and
Penalties imposed on those who violate the rules. Penalties should be applied even-handedly.

Considering the Business Legal Form 88, there are different legal organizational models that have most commonly been adopted by exchanges:
Nonprofit Model;
For-profit Model;
Consumer Cooperative Model; and
Government—Managed Model.

The implications of an exchange adopting any of the above legal forms will depend on the applicable jurisdiction.

A Nonprofit Model for the Knowledge Exchange Bourse 60 is recommended for the following reasons:
It gives the bourses more flexibility in taking decisions.
It minimizes the combined cost of ownership and control for all stakeholders dealing with the Bourse
It is much simpler than other models.
Reduction of fees benefits all the users of the Bourses' services.
Decisions will be based on profit and loss in a framework governed by legislation and supervision to ensure there will not be conflict of interest.
Eliminating the state's control would definitely reflect positively on the market but it must be accompanied with enhancing the level of disclosure and enhancing the level of transparency.

Accordingly, exemplary embodiments of the present invention provide the Business Legal Form 88 of the Knowledge Exchange Bourse 60 to be a Commercial Mutual Nonprofit Firm:
Commercial: refers to the fact that a nonprofit income derives primarily for offering financial intermediaries a marketplace on which to deal for a fee.
Mutual: refers to the fact that the agents who are the prime source of a nonprofit's income also control the organization, which means that the financial intermediaries who trade on the Bourse also control it.
Nonprofit: refers to the fact that the firm is restricted from distributing any profit or surplus that it earns outside the firm and it is allowed to pay only reasonable compensation to its management.

The Governance structure of exemplary embodiments of the Knowledge Exchange Bourse 60 will be a Commercial Mutual Nonprofit Firm that is controlled by and run for the consumers of the firm. It cannot distribute any profits and it cannot operate if its cumulative losses exceed its cumulative gains. The vision of the objective function of the firm is that to maximize consumer surplus subject to breaking even.

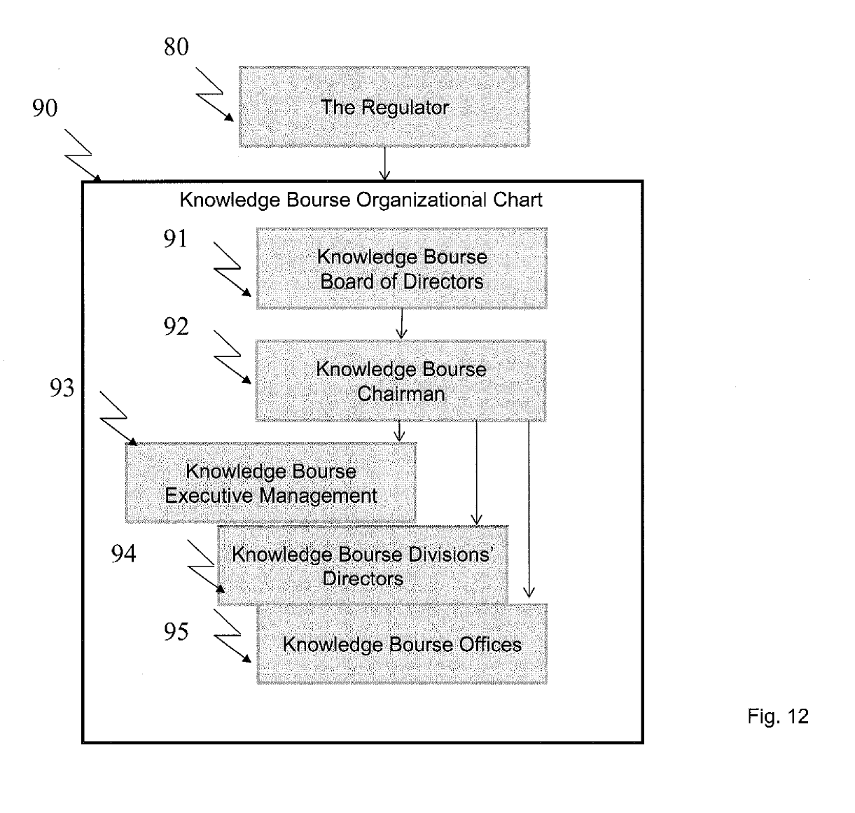

An exemplary Organizational Chart of the Knowledge Exchange Bourse 60 is shown in FIGS. 10 and 12. The Regulator 80 is the foremost authority presiding over the capital markets with a mission to promote and maintain fair, efficient, secure and transparent markets and to facilitate the orderly development of the stock exchanges. The function of an efficient regulator 80 is central to the functioning of a capital market, including the Knowledge Exchange Bourse 60. In various countries, the securities regulator function is situated in:
Central bank;
Ministry of Finance;
Ministry of Commerce;
An independent agency (e.g. Securities Commission); or
A Trade association, which is usually private, such as a stock exchange, in which case it is called a self-regulatory Organization (SRO).

The Regulator 80 supervises the market by setting broad rules and reviewing the rules of conduct. Sometimes the regulator 80 can step in to make basic decisions (India's securities board has this power, for example). The extent and nature of supervision varies considerably across countries. The objectives of the Regulator 80 are:
Protection of Investors;
Ensuring that Markets are Fair, Efficient and Transparent;
Reduction of Systemic Risk; and
Enforcement of Securities Regulations.

In exemplary embodiments, the Board of Directors 91 of the Knowledge Exchange Bourse 60 Organization comprises:
Chairman
Executive Management
Divisions, Directors: Enforcement, Investment Management, Corporation Finance, Trading and Markets, Risk, Safety, and Financial Innovation
Knowledge Exchange Bourse 60 Offices of Public Affairs & Communications
Compliance Inspections and Examinations
Legislative & Intergovernmental/International Affairs
Legal Services
Inspector General
Chief Accountant
Financial Management
Information Technology
Compliance Inspections and Examinations
Administrative Services
Human Resources
General Counsel
Marketing Services
Board of Directors

The board will be responsible for the management of the Knowledge Bourse. As a collective body, it will act in the corporate interest and serve the common interests of the shareholders ensuring the sustainable development of the company. The board will be composed of competent, honest and qualified professionals. Their choice will take account of the specific features of the Knowledge Exchange Bourse 60. The board will regularly evaluate its performance and its relationship with the executive management. The board will set up an effective structure of executive management. It will clearly define the duties of executive management and delegate to it the necessary powers for the proper discharge of these duties. The board will establish strict rules, designed to protect the Knowledge Bourse's interests, in the areas of financial reporting, internal control, and risk management. Board members will:
Act on a fully informed basis, in good faith, with due diligence and care, and in the best interest of the market, members and investors.
Devote sufficient time to their responsibilities.

The Board of Directors 91 responsibilities include:
Ensure compliance with applicable law and take into account the interests of members and other market participants.
Review and guide corporate strategy.
Select, compensate, monitor and, when necessary, replace key executives and oversee succession planning.
Review key executive and board remuneration, and ensure a formal and transparent board nomination process.
Monitor and manage potential conflicts of interest among management, board members and ordinary members of the market.
Ensure the integrity of the market's accounting and financial reporting systems.
Monitor the effectiveness of the governance practices under which it operates, and make changes as needed.
Oversee the process of disclosure and communications.
Independently exercise objective judgment on corporate affairs, in particular, from management.
Consider assigning a sufficient number of non-executive board members, capable of exercising independent judgment, to tasks where there is potential for conflict of interest.

The chairman 92 of the Knowledge Exchange Bourse 60 is the head of the Board of Directors 91 who has been elected by members of that board. The role of a chairman 92 is simply to be a link between the Knowledge Exchange Bourse 60, Board of Directors 91, and Executive Management 93. The roles of the Chairman 92 are:
Setting the Board agenda, ensuring that Directors receive accurate, timely and clear information to enable them to make sound decisions, ensuring that sufficient time is allowed for complex or contentious issues, and encouraging active engagement by all members of the Knowledge Exchange Bourse 60.
Taking the lead in providing a comprehensive, formal and tailored induction program for new Directors, and in addressing the development needs of individual Directors to ensure that they have the skills and knowledge to fulfill their role on the Board and on Board Committees.
Evaluating annually the performance of each Board member in his/her role as a Director, and ensuring that the performance of the Board as a whole and its Committees is evaluated annually. Holding meetings with the non-executive Directors without the executives being present.
Ensuring effective communication with shareholders and in particular that the Knowledge Bourse maintains contact with its principal shareholders on matters relating to strategy, governance and Directors' remuneration. Ensuring that the views of shareholders are communicated to the Board as a whole.
As Chairman of the Nominations Committee, initiating change and planning succession in Board appointments in accordance with procedures agreed upon from time to time by the Board.
Together with the Chief Executive, providing input to the Remuneration Committee in relation to both its recommendations to the Board on the policy for the remuneration of the Executive Directors, and its approval of the detailed terms of service of the Executive Directors.
Together with the Chief Executive, advising the Board in its determination of the fees of the Non-Executive Directors.
In conjunction with the Chief Executive, representing the Knowledge Bourse to customers, suppliers, government, shareholders, financial institutions and the community.

The Chief Executive of the Knowledge Exchange Bourse 60 is responsible for leadership of the Knowledge Exchange Bourse 60 and managing it within the authorities delegated by the Board 91. In particular, the Chief Executive will:
Develop strategy proposals for recommendation to the Board and ensure that agreed strategies are reflected in the business.
Develop annual plans, consistent with agreed strategies, for presentation to the Board for support.
Plan human resourcing to ensure that the Knowledge Exchange Bourse 60 has the capabilities and resources required to achieve its plans.
Develop an organizational structure and establish processes and systems to ensure the efficient organization of resources.
Be responsible to the Board for the performance of the business consistent with agreed plans, strategies, and policies.
Lead the executive team, including the development of performance contracts and appraisals.
Ensure that financial results, business strategies and, where appropriate, targets and milestones are communicated to the investment community.
Develop and promote effective communication with shareholders and other relevant constituencies.
Ensure that business performance is consistent with the Business Principles.
Ensure that robust management succession and management development plans are in place and presented to the Board from time-to-time.
Develop processes and structures to ensure that capital investment proposals are reviewed thoroughly, that associated risks are identified and appropriate steps taken to manage the risks.
Develop and maintain an effective framework of internal controls over risk in relation to all business activities including the Group's trading activities.
Ensure that the flow of information to the Board is accurate, timely, and clear.
Establish a close relationship of trust with the Chairman, reporting key developments in a timely manner and seeking advice and support as appropriate.

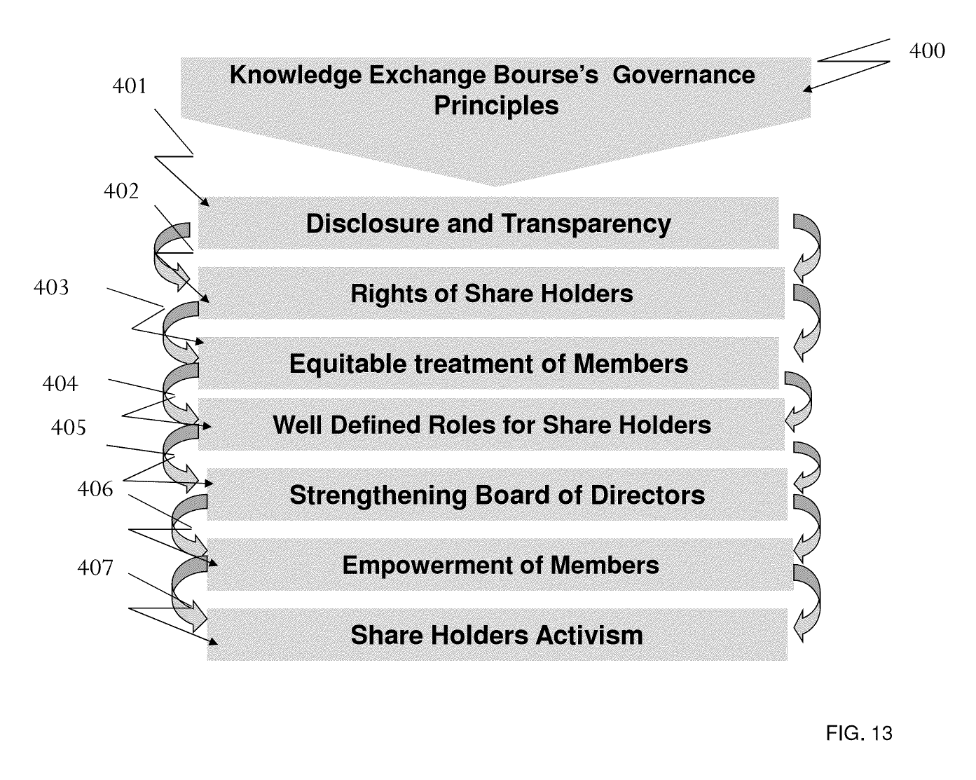

FIG. 13 displays a flow chart of the Governance Principles of the Knowledge Exchange Bourse in accordance with an exemplary embodiment of the present disclosure. The Governance Principles 400 of the Knowledge Exchange Bourse 60 are listed in FIG. 13. The first principle is Disclosure and Transparency 401. Accordingly, the Knowledge Exchange Bourse 60 governance framework will ensure that timely and accurate disclosure is made on all material matters regarding the markets, including the financial situation, performance, ownership, and governance of the markets. The Knowledge Exchange Bourse 60 framework will set and monitor transparency regulation in all the activities of the Knowledge Exchange Bourse 60 and operations Disclosure on the markets should include, but not be limited to, material information on:
Financial and operating results of the markets;
Markets' objectives;
Voting rights of members;
Members of the board and key executives, and their remuneration;
Historic risk profile and potential risk factors;
Material issues regarding employees and other stakeholders; and
Governance structures and policies.

Information on the markets will be prepared, audited, and disclosed in accordance with high quality standards of accounting, financial and non-financial disclosure, and audit. An annual audit will be conducted by an independent auditor in order to provide an external and objective assurance on the way in which financial statements have been prepared and presented. Channels for disseminating information will provide for fair, timely, and cost-efficient access to relevant information by users.

Based on the principle of the Rights of Shareholders 402, the Knowledge Exchange Bourse 60 governance will promote shareholders' rights including the rights to:
Participate in, and to be sufficiently informed on, decisions concerning fundamental corporate changes;
Participate effectively and vote in general shareholder meetings and should be informed of the rules, including voting procedures that govern general shareholder meetings;
Be provided with sufficient and timely information concerning the date, location and agenda of general meetings;
Be able to vote in person or in absentia, with equal effect given to votes whether cast in person or in absentia;
Secure methods of ownership registration;
Convey or transfer shares;
Obtain relevant information on the corporation on a timely and regular basis;
Participate and vote in general shareholder meetings;
Elect members of the board; and
Share in the profits of the company

The Equitable Treatment of Members 403 principle of the Knowledge Exchange Bourse 60 governance framework will ensure the equitable treatment of Bourse members. All members will have the opportunity to obtain effective redress for violation of their rights. All members of the same class will be treated equally, and all members will be able to obtain information about voting rights. Any changes in voting rights will be subject to membership vote. Votes will be cast by custodians or nominees in a manner agreed upon by the markets' constitutions. Processes and procedures for general members meetings will allow for equitable treatment of all members. The Knowledge Exchange Bourse 60 procedures will not make them unduly difficult or expensive to cast votes. Insider trading and abusive self-dealing will be prohibited. Members of the Knowledge Exchange Bourse 60, Board and managers will be required to disclose any material interests in transactions or matters affecting the markets.

According to the Well-Defined Roles of Stakeholders 404, the Knowledge Exchange Bourse 60 governance framework will recognize the rights of stakeholders as established by law and encourage active cooperation between the Knowledge Exchange Bourse 60, members and other stakeholders in creating wealth, jobs, and the sustainability of financially sound enterprises. The Knowledge Exchange Bourse 60 governance framework will assure that the rights of stakeholders that are protected by law are respected and will permit performance-enhancing mechanisms for stakeholder participation. Where stakeholder interests are protected by law, they will have the opportunity to obtain effective redress for violation of their rights. Where stakeholders participate in the Knowledge Bourse governance process, they will have access to relevant information.

According to the principle of Strengthening Board of Directors 405 the Knowledge Exchange Bourse 60 governance framework will ensure the strategic guidance of the market, the effective monitoring of management by the board, and the board's accountability to the market and its members. The Board members 91 of the Knowledge Exchange Bourse 60 will select, compensate, monitor and, when necessary, replace key executives and oversee succession planning. Board members 91 of the Knowledge Exchange Bourse 60 will act on a fully informed basis, in good faith, with due diligence and care, and in the best interest of the market, members and investors. Board members 91 will review and guide corporate strategy, e.g., major plans of action; risk policy; annual budgets and business plans; setting performance objectives; monitoring implementation and corporate performance; and overseeing major developments.

According to the principle of Empowerment of Members 406, the Knowledge Exchange Bourse 60 governance framework will encourage formal members' proposals and members' dialogue that involve a discussion or negotiation initiated by a member with market management to effect change on a particular issue of concern. Knowledge Exchange Bourse 60 members will claim their power as owners of the capital market to influence the market's behavior.

The Knowledge Exchange Bourse 60 governance framework will encourage and promote Shareholders' Activism 407 of the listed companies. Examples are:
Investor action networks;
Social Investment Forums;
Investor-environmentalist Alliances; and
Institutional Investors Councils.

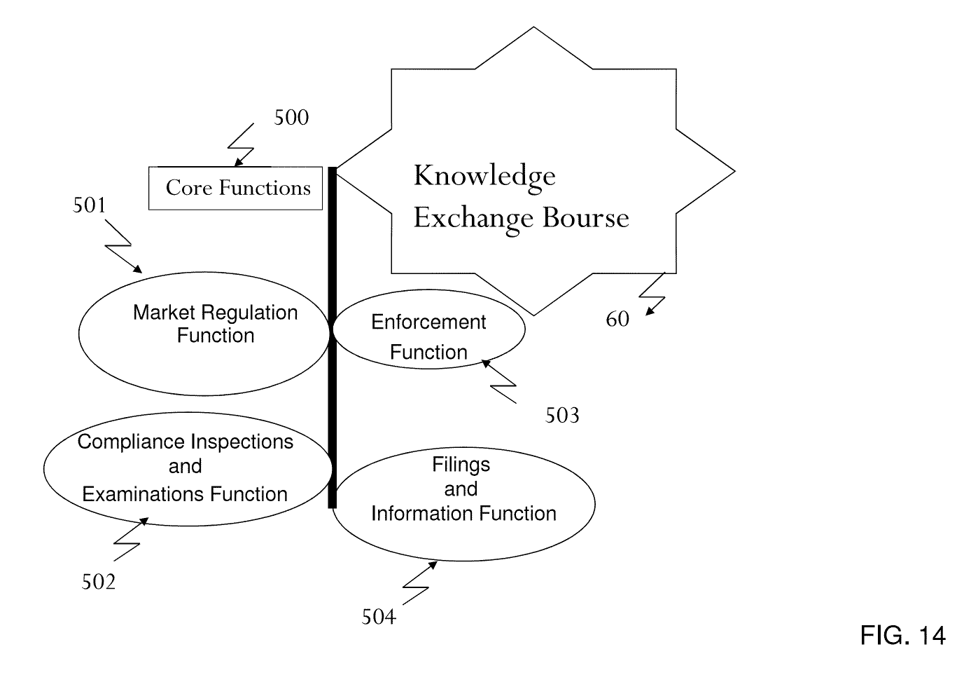

FIG. 14 shows core functions of the Knowledge Exchange Bourse in accordance with exemplary embodiments of the present disclosure. The Core Functions 500 of the Knowledge Exchange Bourse 60 comprises the Market Regulation Function 501, which is responsible for:
Overseeing members' trading operations and market activities in order to maintain effective, centralized, market regulation. Such regulation, which is not restricted to trading on the stock exchange, is a role generally played by a primary market and addresses general issues of trading ethics and investor protection in the markets.
Setting the rules governing the operation of knowledge market, monitors trading activity, and administers and enforces the rules through its regulatory policy, market surveillance and enforcement functions.
Regulating trading in knowledge securities and in the over-the-counter markets.
Regulating materials affecting the privacy of individuals and systems of records maintained by the knowledge stock market.
Regulating certain activities of brokers, dealers and investment advisers.

Knowledge Exchange Bourse 60 as a Self-Regulatory Organization (SRO): The model chosen by the Knowledge Exchange Bourse 60 is a self-governing one reflecting enlightened self-interest on the part of participants. The Knowledge Exchange Bourse 60 would not be successful if participants did not have confidence that they would be treated fairly and honestly by their broker and that the market itself operated fairly. The Knowledge Exchange Bourse 60 restricted access, sets rules and regulations governing the business conduct of its members, and set rules and procedures designed to ensure that bargains would be honored. The Knowledge Exchange Bourse 60, as a Self-Regulatory Organization (SRO), benefits Ethical standards. SROs have the ability to impose ethical standards which go beyond those which can be imposed by statutory laws, such as:
Accountability: Self-regulators are directly accountable to their members—and often the government—for actions taken or not taken. Thus, the SRO system carries a built-in motivation to take the regulatory course which is the most effective and least disruptive to market efficiency.
Acceptability: Self-regulation operates in an environment where there is a willingness to accept regulations promulgated by professional peers as the necessary and appropriate action for the common good of the group.
Sensitivity: Self-regulators have the business sensitivity to know when a regulation will be workable and beneficial to the investors and users of the markets.
Participation: The opportunity of all organizations that are subject to the regulations to participate at all levels of the self-regulatory process makes it easier to accept new regulations which often mean restrictions or impediments to legitimate business activities.
Checks and Balances: Self-regulation has a built-in system of checks and balances. The organizations which must comply with the regulations, such as companies who list their securities and members and investors who do business on the Knowledge Bourse, are less reluctant to make their views known to the SRO with whom they have a business relationship.
Responsiveness: Self-regulators are able to identify and comprehend complex problems at an early stage and can respond with a solution or approach to meet the specific or particular development or problem situation. This ability to respond to developments as they are occurring often can ameliorate or lessen potential problem situations before they reach a crisis stage.
Expertise: Self-regulators also have a reservoir of expertise in the offices and staff of their member organizations which can be drawn upon at different levels and stages of the self-regulatory process. Thus, SROs have a closeness to, and familiarity with, the field of financial activity to be regulated.
Cost effectiveness: Self-regulation, which often operates as a part of a voluntary membership organizational structure, has a built-in incentive to minimize the cost of regulation to investors and users of the markets.
Effective use of government resources: Self-regulation permits the government to devote its resources to activities which cannot be adequately served by self-regulation, such as criminal proceedings, legal actions on insider trading and manipulative practices by nonmembers.
Good business sense: Self-regulation makes good business sense for both those concerned about investor protection and those subject to the regulation.

The Compliance Inspection and Examination Function 502 is responsible for:
Compliance inspections and examinations relating to the regulation of Knowledge Bourse.
Investigating knowledge securities frauds, manipulations, and other violations, and the imposition and enforcement of legal sanctions therefore.

The Enforcement Function 503 is responsible for:
Enforcing compliance with the law by all persons affected thereby.
Enforcing disclosure requirements in the soliciting of proxies for meetings of security holders by companies whose securities are registered.
Supervising and conducting all enforcement.
Recommending the institution of administrative and injunctive actions arising out of such enforcement activities.
Determining the sufficiency of evidence to support the allegations in any proposed complaint.
Reviewing cases to be recommended to the Department of Justice for criminal prosecution.
Granting or denying access to nonpublic information in the Commission's enforcement files.

The Filings and Information function 504 is responsible for:
Receipt and initial handling of all public documents filed at the headquarters office.
Determining acceptability, extracting data for market input, calculating fees, conducting cursory and substantive examinations, assigning filings to branches and preparing deficiency correspondence.
Custody and control of the official records.
Authenticating all documents produced for administrative or judicial proceedings.
Maintaining liaison with the National Archives and Records Service and other Government agencies.
Provide filer-support services relating to receipt of fees and filings for all types of filers, regardless of filing media.
Ensure that all information contained in public filings is timely made available to investors.

The Knowledge Exchange Bourse 60 establishes rules for fair trading practices and regulates the trading activities of its members according to those rules. The Knowledge Exchange Bourse 60 will:
Provide knowledge-based companies with the facility to raise capital for expansion through selling shares to the investing public.
Facilitate knowledge-based companies' growth by expanding product lines, increasing distribution channels, hedging against volatility, increasing market share, or acquire other necessary business assets. A takeover bid or a merger agreement through the stock market will be one of the common ways for a company to grow by acquisition or fusion.
Influence improving companies management standards and efficiency in order to satisfy the demands of their shareholders and the more stringent rules for public corporations imposed by Knowledge Exchange Bourse 60 and the Regulator 90.
Create investment opportunities for small investors through investing in knowledge shares which will be open to both large and small investors.
Enable, support, and facilitate the trading of knowledge commodities among individuals or groups.
Serve as a forum for discussion of relevant knowledge policy issues.

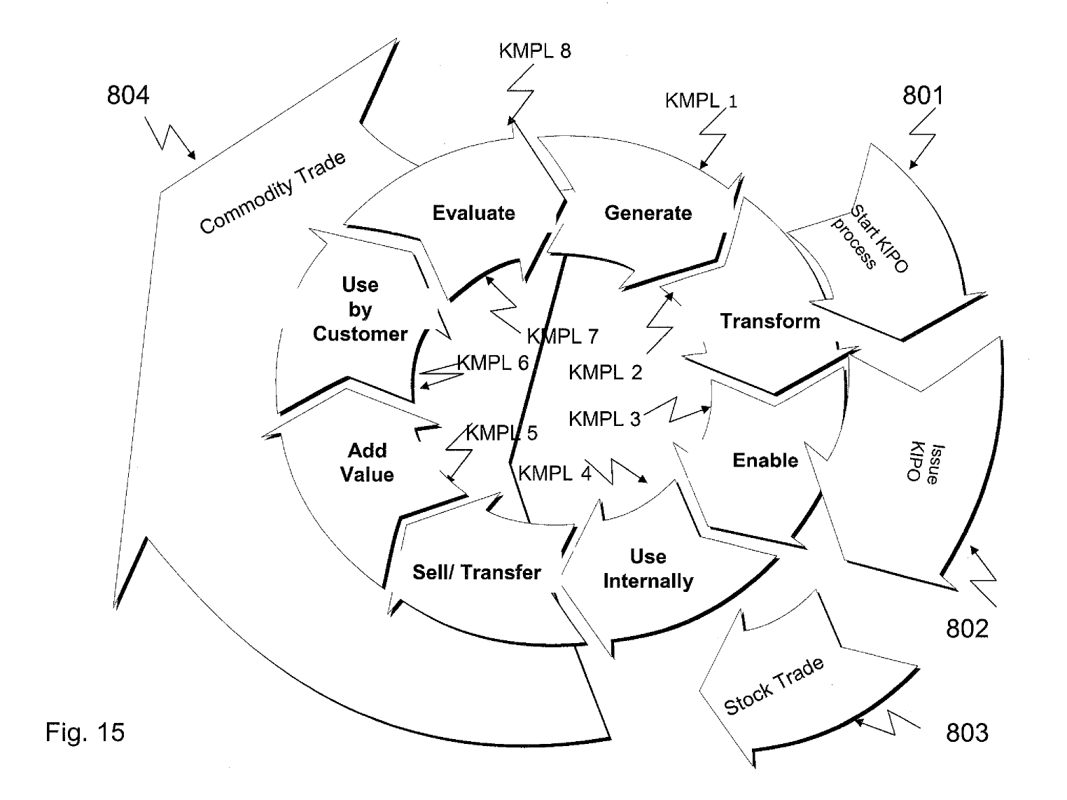

FIG. 15 illustrates the maturity of a knowledge-based organization in accordance with exemplary embodiments of the present disclosure based on FIG. 2. In FIG. 15, the maturity of a typical knowledge-based organization (KBO) is analyzed using the KMPL maturity model for the product/service value chain. Reaching KMPL-2, the KBO starts the reparation for the KIPO process 801; when reaching KMPL-3, the KBO issues the KIPO 802. When reaching KMPL-4, Knowledge Securities are traded at the Knowledge Exchange Bourse 803. Knowledge Commodities are traded at the Exchange Knowledge Bourse 804, from reaching KMPL-5 to the end of the maturity cycle.

In an exemplary embodiment of the Knowledge Exchange Bourse, new financial instruments are introduced for trade in the Knowledge Stock Exchange side and in the Knowledge Commodities Exchange side. The instruments are based on the endowment concept. Endowment is a permanent fund of property or money established to benefit an institution or person. It has a specific purpose defined for which the income derived from the money or property is to be applied.

In an endowment fund, the principal is invested, and only a portion of the investment earnings is spent. The rest of the earnings are directed back into the fund so that the endowment grows over time. In this manner, the endowment becomes a perpetual source of funding for whatever the donor wishes to achieve. As an example, The National Endowment for the Arts is the largest annual funder of the arts in the United States. It supports works of artistic excellence, advancing learning in the arts, and strengthening the arts in communities throughout the country.

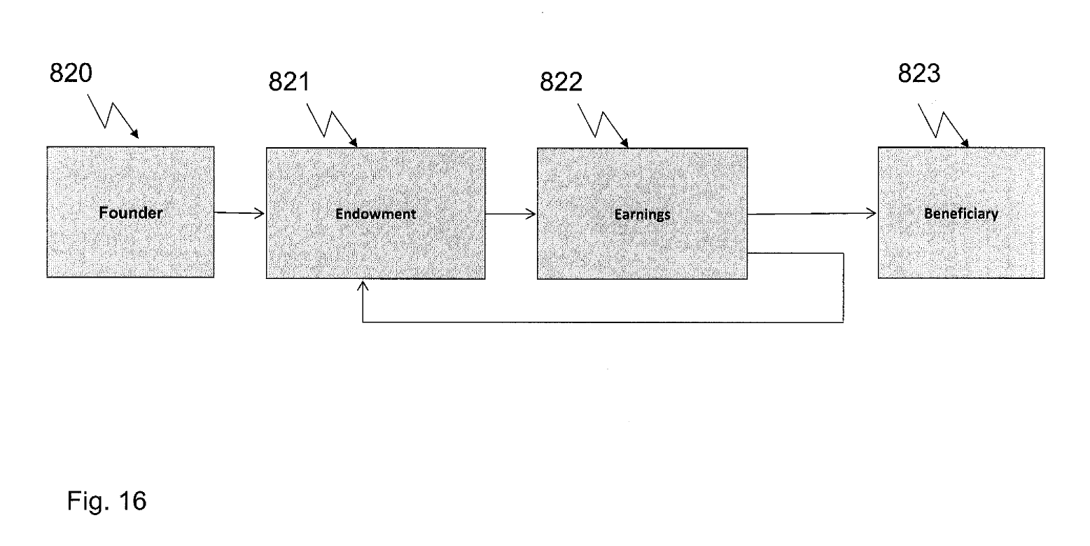

FIG. 16 shows a flow chart of a typical endowment system concept in accordance with an exemplary embodiment of the present disclosure. FIG. 16 shows a flow diagram of a typical endowment scheme. The Founder(s) 820 allocates the Endowment 821 in the form of investment property funds, or other money generating assets that generate Earnings 822 which is the income derived from the investment property or funds. A portion of the investment earnings is directed to the Beneficiary 823, which could be an individual or institution. The rest of the earnings are directed back into the fund.

Management of the Endowment is conducted by the Board of Trustees in consultation with the institution's administration (Beneficiary). The board determines the objectives of the endowment and the policies that will guide its management, explains them in a written statement, and periodically reviews and updates the statement. The elements of the endowment management comprise:
Payout Policy: In deciding the amount to be transferred from the endowment to the operating budget each year, the Board, working with the administration, must carefully balance two opposing claims: the current needs of the institution and its constituencies versus the obligation to preserve the endowment for future generations.
Asset Allocation. In seeking the return needed to support payout policy at an acceptable level of investment risk, the Board starts with the most crucial decision—the balance of the endowment portfolio among the asset classes, a decision that the Investment Committee should review each year and maintain through rebalancing at least annually.
Manager Selection. Investment managers are studied in depth, not just for past performance, and selected to affect a diversification that will optimize return while limiting overall portfolio risk.
Risk Management. Risk resides in the possibility of failing to meet the Board's objectives, and make sure every facet of the endowment management system, internal and external, has built-in disciplines to recognize the risks and promptly neutralize them.
Costs: The costs of the investment program can quietly undercut returns. Frequently, the Committee fails to implement cost controls worth mentioning. The costs they should be concerned about are almost innumerable. The major costs include cost of consultants that are employed to help them through the thicket. Then, they may decide to use a number of different advisors to manage the portfolio, and they are going to need help selecting them. So they are going to spend money on that. And then, each advisor is going to charge a fee. That is a rather significant portion of the total.

The disadvantages of the current endowment system are:
No public monitoring to the performance of the board;
Costs of the investment program can quietly undercut returns;
High cost of management; and
Roles of the trustees, the business or investment officer and staff, and consultants are not defined.

Accordingly, exemplary embodiments of the present invention introduce a novel endowment system. The endowment investment property will be used to issue endowment stocks. Part of the stocks will be endowment preferred stocks allocated to the beneficiary institution and the other part will be endowment common stock to be sold at the knowledge bourse to investors. Exemplary embodiments provide for the endowment investment used to buy investment property. Part of the endowment preferred stocks dividends will be provided to the institution as determined by the endowment policy; other parts will be directed back into the fund so that the endowment grows over time. The earnings from the institution (for example, a university) research/university chair/organization will be directed back into the fund so that the endowment grows over time. The endowment common stock will be sold to the investors and the price will be directed back into the fund. In this manner, the endowment becomes a perpetual source of funding for whatever the donor wishes to achieve.

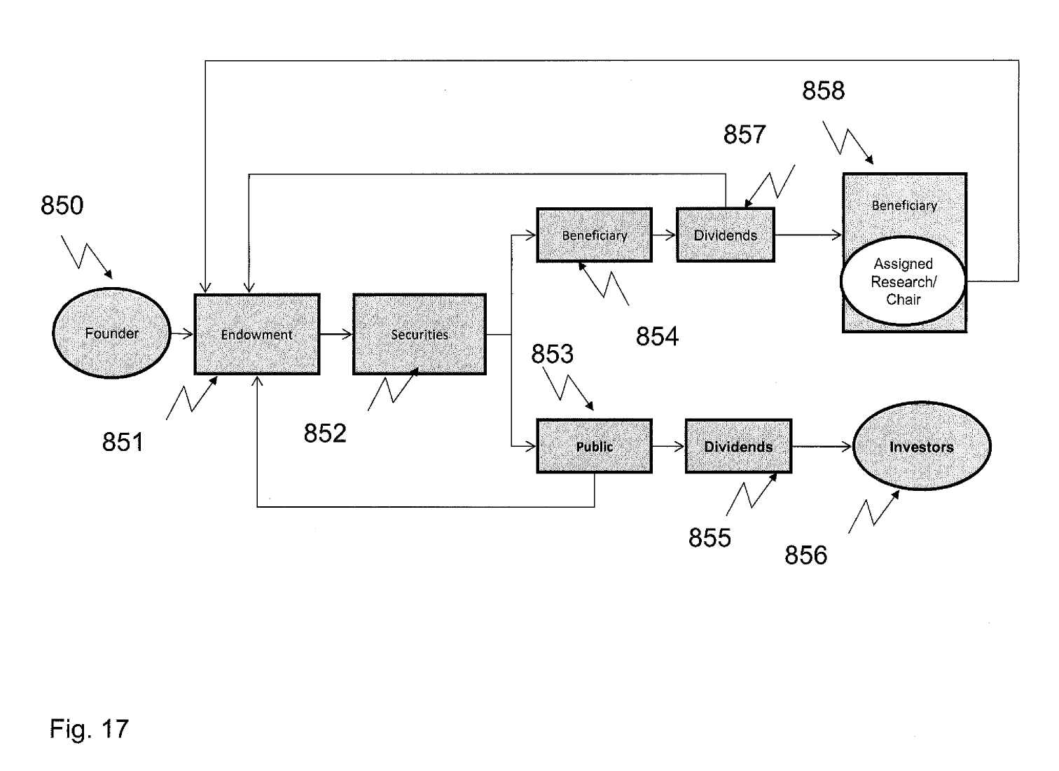

FIG. 17 shows a novel endowment-security system in accordance with an exemplary embodiment of the present disclosure. FIG. 17 shows the flow diagram of the novel endowment system in accordance with an exemplary embodiment of the present invention. The Founder(s) 850 allocates the Endowment 851 in the form of investment property funds or other money generating assets that are converted into Securities 852 for investment on the Knowledge Exchange Bourse. The securities are sold in part to the Public 853 and the rest is allocated to the Beneficiary 854.

The price per share of the Securities sold to Public 853 is directed back into the fund and the generated Dividends 855 are given to the Investors 856, a portion of the earnings from the Dividends 557 from the securities allocated to the Beneficiary 854 go to the Beneficiary 858, which could be an institution or assigned Research/Chair, and the rest of the earnings are directed back into the fund of the Endowment 851. Earnings from Research/University Chair/Organization 858 that benefited from endowment funds will be passed to the Endowment 851.

The accrued advantages of the novel endowment instrument include: public monitoring of the performance of the board and investment, lower costs of the investment program, lower cost of management and roles and accountability of the board of trustees, clear and well-defined roles for business or investment officer and staff.

We claim:

1. A method for determining knowledge maturity risk, comprising:
obtaining knowledge development stages based on technology life cycle;
characterizing the knowledge development stages in the context of knowledge tangible outcomes comprising Generate, Transform, Enable, Use Internally, Sell/Transfer, Add Value, Use by Customers, and Evaluate;
associating a risk weight to each of said outcomes;
determining a maturity score as a product of said risk weight and completion status; and
determining the knowledge maturity risk based on said maturity score.

2. The method of claim 1, wherein the knowledge maturity risk is high when the maturity score is less than 31, medium when the maturity score is greater than 31 but less than 71, and low when the maturity score is greater than 71.

3. The method of claim 1 wherein the technology life cycle is based on technology readiness in advancing technology from concept to market, said technology readiness being identifiable by a plurality of levels comprising technology concept and/or application formulated, system/subsystem model or prototype demonstration in a relevant environment, and actual system completed and qualified through test and demonstration.

4. The method of claim 1, wherein risk is based on unknowns associated with technology and is approximately maximum when the idea is first captured through analytical and experimental proof of concept, approximately half after analytical and experimental proof of concept through demonstration in an actual environment, approximately a quarter after demonstration in an actual environment to realization in a proven operational system, and minimum after realization in the proven operational system.

5. The method of claim 1, further comprising characterizing the knowledge development stages as high risk for knowledge tangible outcomes comprising formulation of basic ideas, performing basic research on said basic ideas, observing and reporting principles, generating content with intrinsic value and potential usefulness, transforming the content generated into concepts and/or applications, formulating proof-of-concept prototypes, and demonstrating characteristics of said prototypes in an operational environment.

6. The method of claim 1, further comprising characterizing the knowledge development stages as medium risk for knowledge tangible outcomes comprising enabling use of new knowledge products/services, validating the knowledge products/services in a controlled environment, validating the knowledge products/services in operational environment, using the said knowledge products/services internally, and proving the usefulness of the said knowledge products/services.

7. The method of claim 1, further comprising characterizing the knowledge development stages as low risk for knowledge tangible outcomes comprising packaging knowledge products/services for external use, selling/transferring said knowledge products/services to customers for external use, increasing availability, enhancing utility, or adding value to the knowledge products/services by intermediaries, using the knowledge products/services by customers with related knowledge to benefit sectors/markets, evaluating the knowledge products/services to improve performance, and deriving new products to support future demands of other sectors/markets.

8. The method of claim 1, wherein understanding and assessment of the maturity score aid in establishing timing for preparation of a knowledge initial public offering (KIPO), issuance of the KIPO, trading in a knowledge stock exchange, and trading in a knowledge commodities exchange.

9. A knowledge bourse, comprising:
a plurality of knowledge market offerings comprising knowledge initial public offerings, follow-on knowledge market offerings, secondary knowledge market offerings, and knowledge transfer market offerings;
a plurality of knowledge financial products comprising knowledge securities based on fungible, negotiable instruments issued by a knowledge-based organization; and
a plurality of rules governing activities directed to the knowledge market offerings and knowledge financial products.

10. The knowledge bourse of claim 1, wherein the knowledge securities comprise knowledge equity securities, knowledge debt securities, and special knowledge financial instruments.

11. The knowledge bourse of claim 10, wherein the knowledge equity securities comprise knowledge common stock, knowledge preferred stock, knowledge tracking stock, and knowledge warrants.

12. The knowledge bourse of claim 10, wherein the knowledge debt securities comprise knowledge bonds.

13. The knowledge bourse of claim 10, wherein the special knowledge financial instruments comprise knowledge research clusters stock, knowledge institutions cluster stock, education preferred stock, and human endowment stock.

14. The knowledge bourse of claim 9, wherein the rules comprise data dissemination, order routing, order execution, matching, clustering, and settlement.

15. A knowledge commodities exchange, comprising:
a knowledge spot market wherein knowledge commodities are bought and sold for immediate delivery; and
a knowledge derivatives market comprising a plurality of knowledge commodity financial products including knowledge commodity forward contracts and knowledge commodity futures contracts.

16. The knowledge commodities exchange of claim 15, wherein the knowledge commodities forward contract comprises a non-standardized contract between two parties to buy or sell a knowledge product or service at a specified future date and price.

17. The knowledge commodities exchange of claim 15, wherein the knowledge commodities futures contract comprises a standardized contract between two parties to buy or sell a knowledge product or service at a specified future date and price.

18. The knowledge commodities exchange of claim 15, further comprising a clearing house wherein members of the bourse are required to clear trades at the end of each trading session and to deposit a sum of money based on clearing house requirements sufficient to cover the member's debit balance.

19. The knowledge commodities exchange of claim 15, wherein the commodities comprise knowledge raw products that can be developed into consumer goods and equipment, knowledge raw material such as an intellectual property and invention being applied to technology or a product that meets needs, and futures contracts on human capital essential for producing knowledge products and generating revenue.
